(19) United States
(12) Patent Application Publication
(10) Pub. No.: US 2016/0300208 A1
(43) Pub. Date: Oct. 13, 2016

(54) Monetary Mobile, a mobile application that captures calls, expense documents, mileage, other documents, and time so the user can log or bill it

(71) Applicant: Lynne Hampton, Royal Palm Beach, FL (US)

(72) Inventor: Lynne Hampton, Royal Palm Beach, FL (US)

(73) Assignee: 1 GLOBAL LLC, A FLORIDA LIMITED LIABILITY COMPANY, Royal Palm Beach, FL (US)

(21) Appl. No.: 14/683,179

(22) Filed: Apr. 10, 2015

(51) Int. Cl. G06Q 20/14; H04L 12/58; G06Q 40/00; H04W 4/00

(52) U.S. Cl. CPC G06Q 20/145; H04W 4/003; H04L 51/08; G06Q 40/128; G06Q 20/14

(57) ABSTRACT

Monetary Mobile is a process (mobile application) whereby mobile phone users can capture calls, scan documents or receipts, record mileage, or clock their time via a stop watch or timer and then email a description of each to the user's billing department, assistant (or to him/herself) or any pre-designated recipient. The purpose of emailing the descriptions is so that the user can bill his/her clients for that time or expense, or log important conversations, expenses and/or mileage, or meetings. The app is not designed to be a billing program, though a nexus is provided so that it will work with an independent billing program.

### PRIOR ART

The inventor did not find a mobile application that has the features that Monetary Mobile has. There are applications that are strictly billing programs, and those do not provide the ability to directly capture calls, time, expenses or mileage. And there are applications that provide scanning, timer, and mileage trackers individually, but none provides the combination of features in the format as this invention, Monetary Mobile, does. Monetary Mobile provides a simplified means for users to complete a billing (or description) screen and have that description sent directly to whomever s/he wishes. The key to Monetary Mobile is its simplicity and automation.

### DESCRIPTION OF THE INVENTION

Professionals who bill by the hour lose a lot of money by failing to bill for calls, time, expenses, and mileage while out of the office. This invention provides a very simple method to help those busy professionals capture calls, time and expenses for billing clients. Further, the app is designed to help other business people to capture calls, time and expenses and documents for other than billing purposes; for example, sales people can describe calls with existing or potential clients and send emails to themselves as a means of keeping track of those calls. As well, these sales professionals can immediately scan receipts when entertaining existing or potential clients and have PDFs of those receipts emailed to themselves for recordkeeping purposes. The stop watch/timer function can allow any professional manage their time better, too, by keeping track of the length of time they spend speaking with clients, attending networking events, etc. The mileage function allows the user to manually enter the miles shown on the odometer at the start of a trip and again at the end of that trip. The app calculates the number of miles per trip and has the billing screen feature available.

Drawings are attached hereto immediately following the Description of Drawings See Exhibit 1

### DESCRIPTIONS OF DRAWINGS

FIG. 1. Overview of invention's flow, functions, and features

FIG. 1 provides an overview of the entire invention, from installation from the appropriate platform (Android, Apple, Blackberry, and Windows, individually, “Platform”) to Exiting the app from various points. Each of the functions/features is described separately in FIGS. 2 through 13, as follows.

FIG. 2. “Installation” flow

Smart phones typically come equipped with standard applications for use with the specific provider's or platform's phones, for example, applications for: dialing the phone, managing contacts, messaging, accessing the internet, displaying photos, taking pictures, calculating figures, navigating, sending email, etc. If the smart phone user wants particular applications that do not come pre-installed, the user must access those applications through the smart-phone specific “store,” such as Google's Play Store or Apple's App Store.

FIG. 2 describes the step-by-step flow for downloading and installing the Monetary Mobile app, starting with the initial download from the appropriate Platform's store.

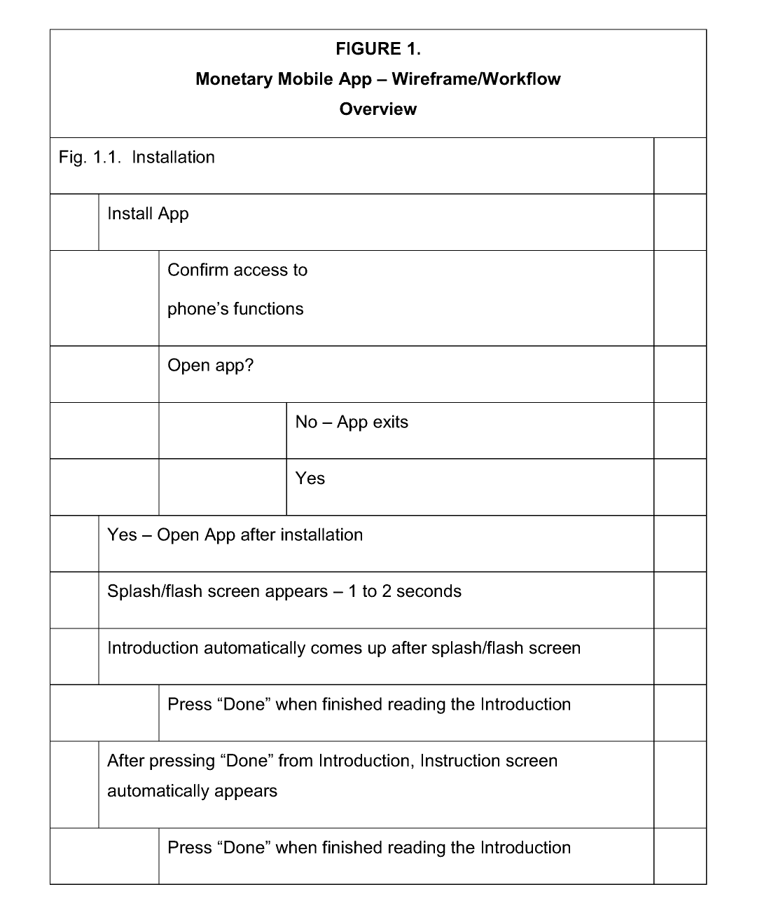

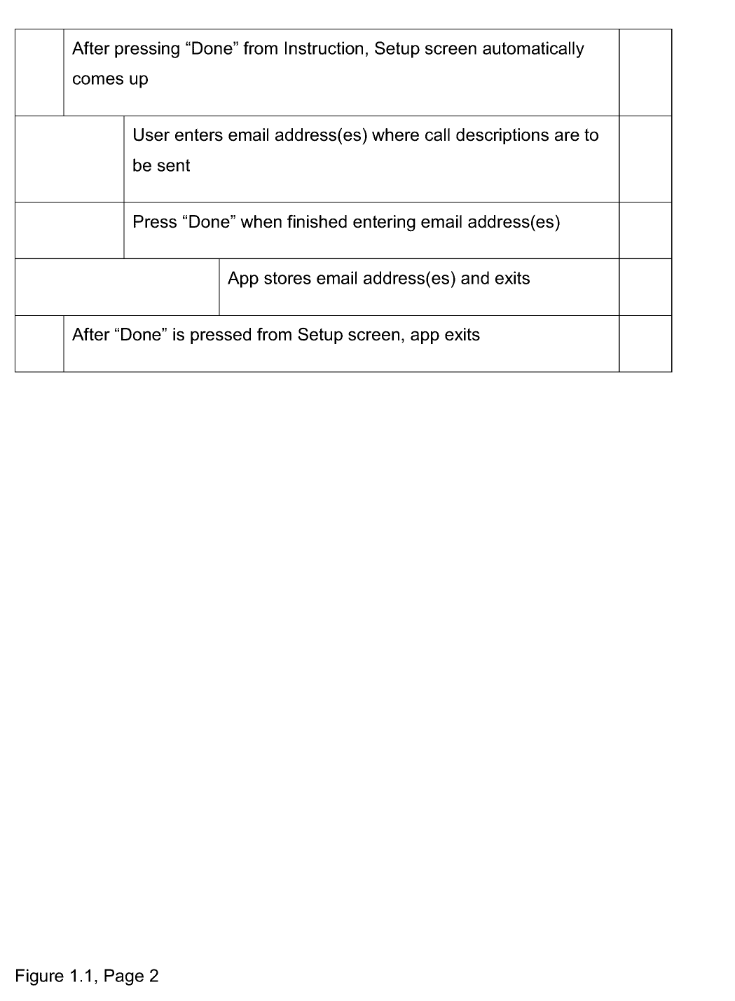

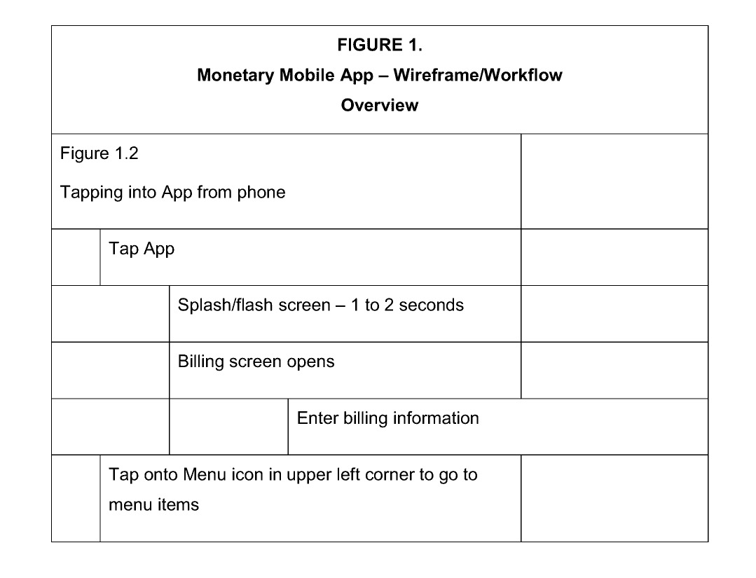

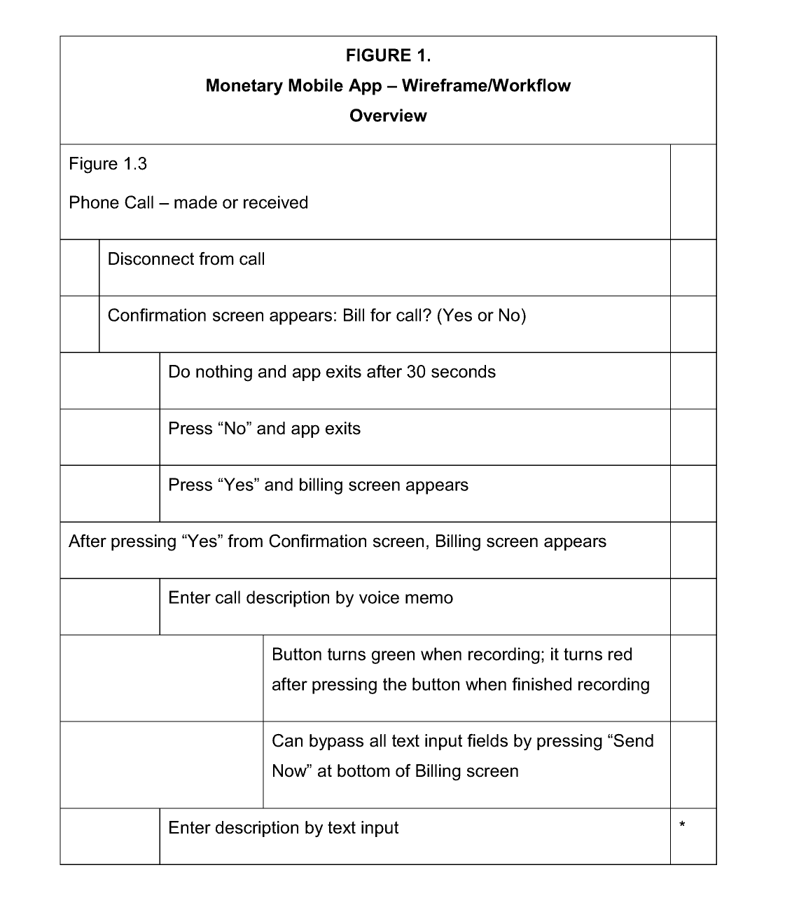

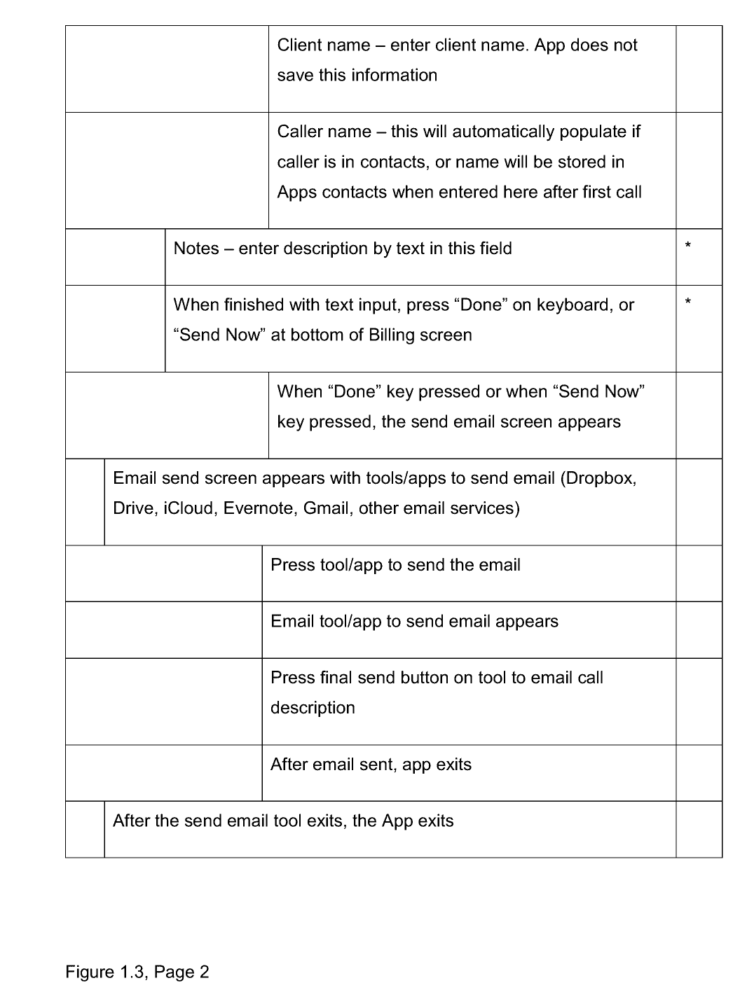

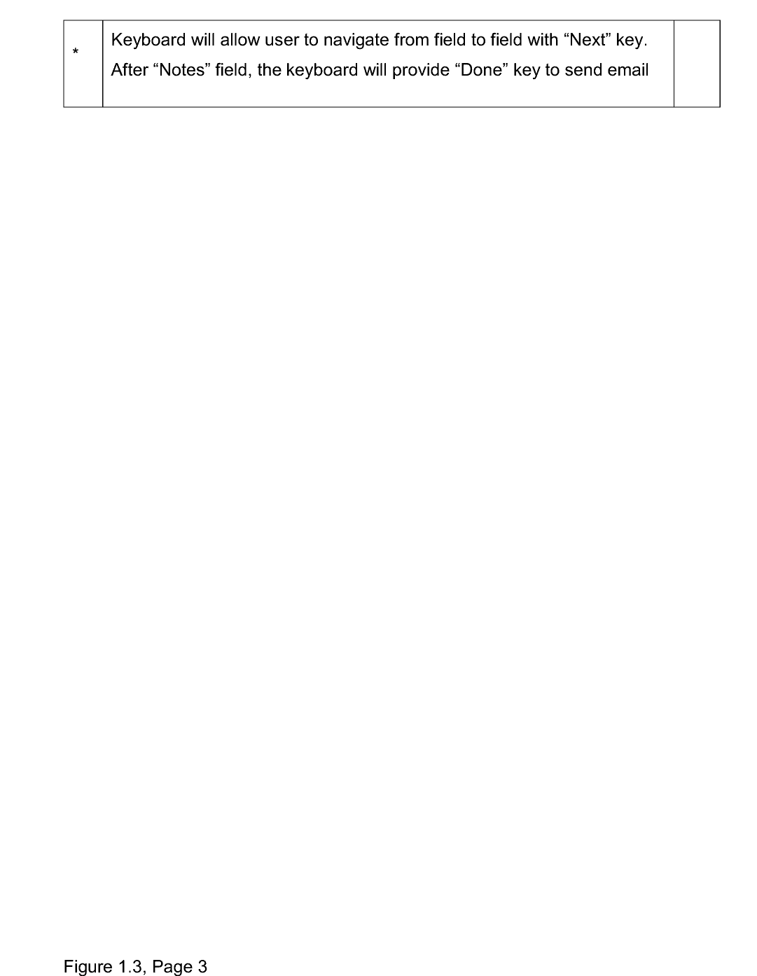

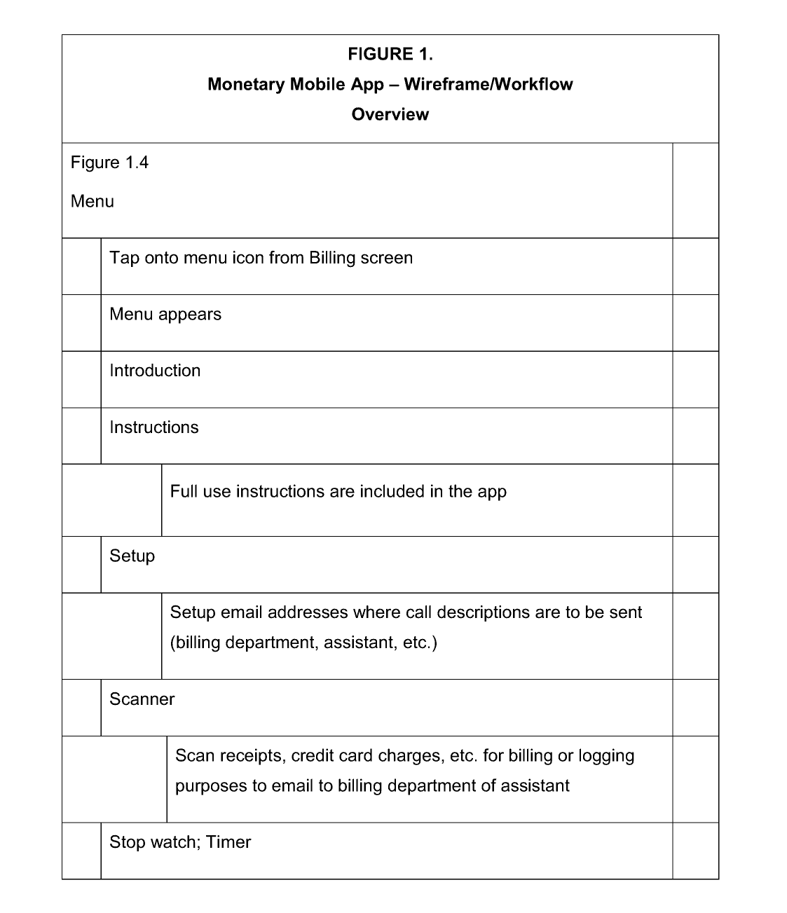

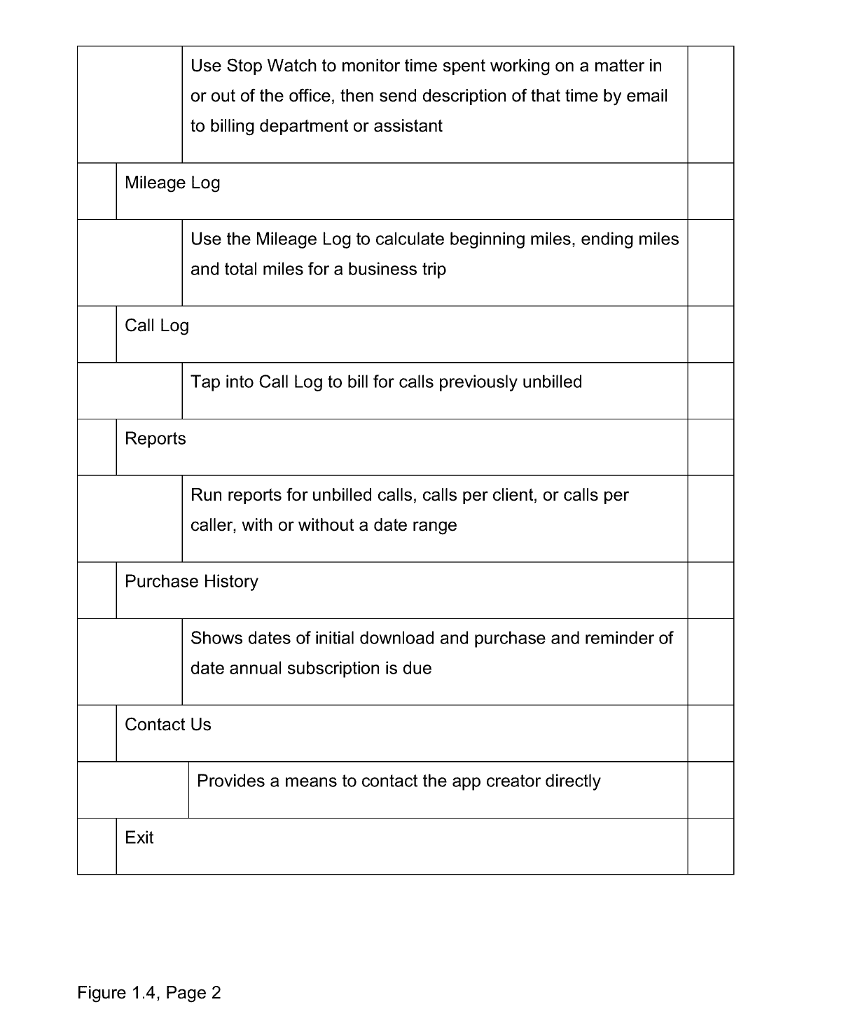

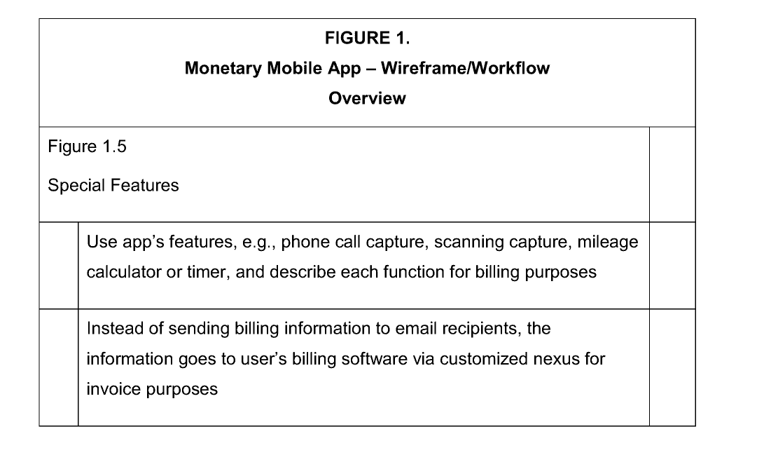

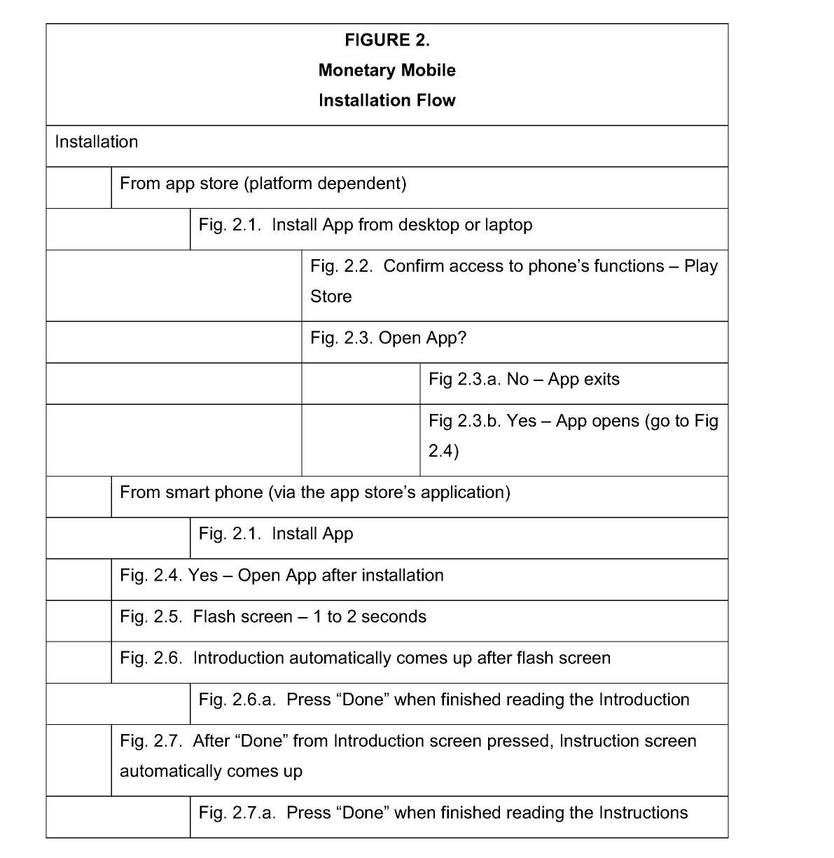

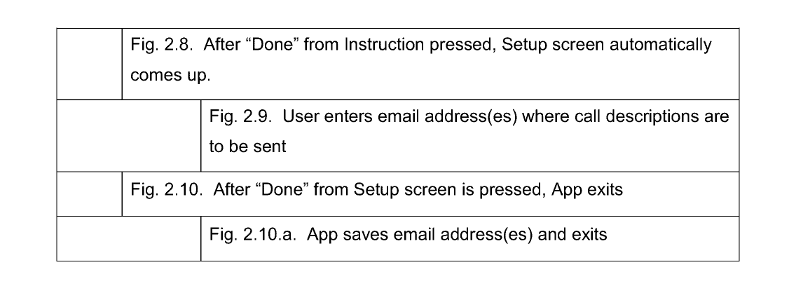

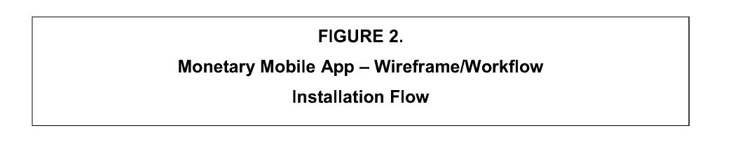

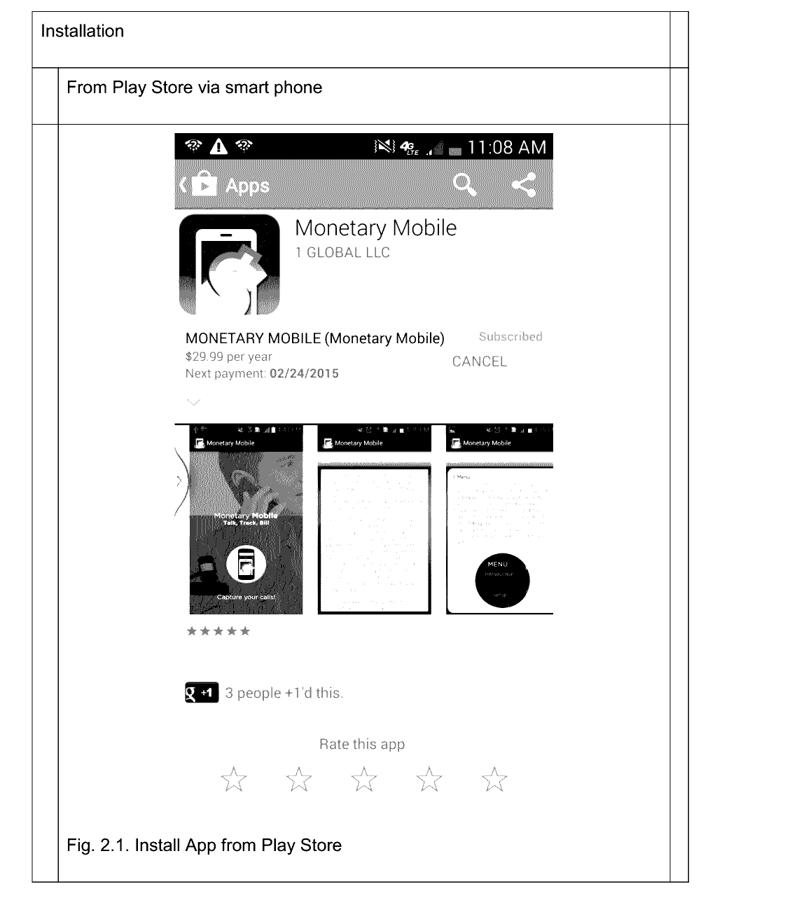

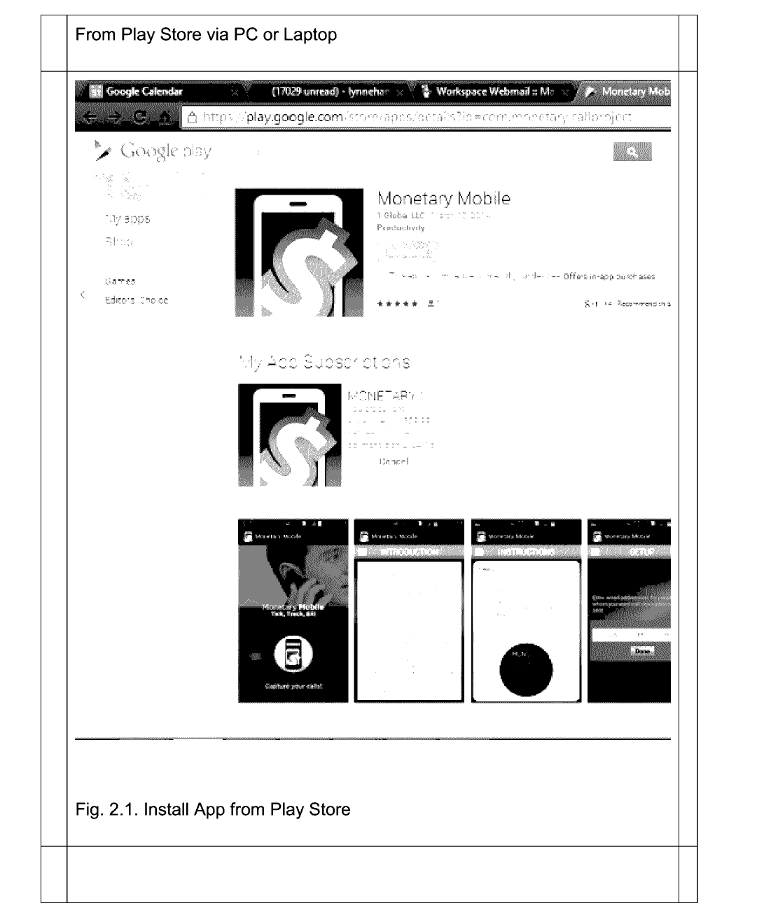

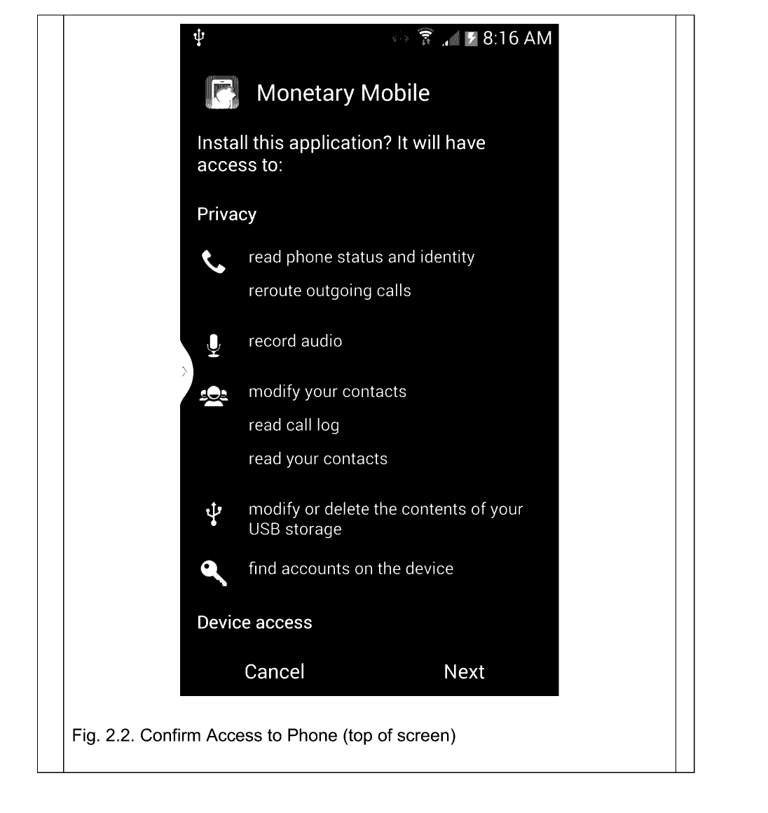

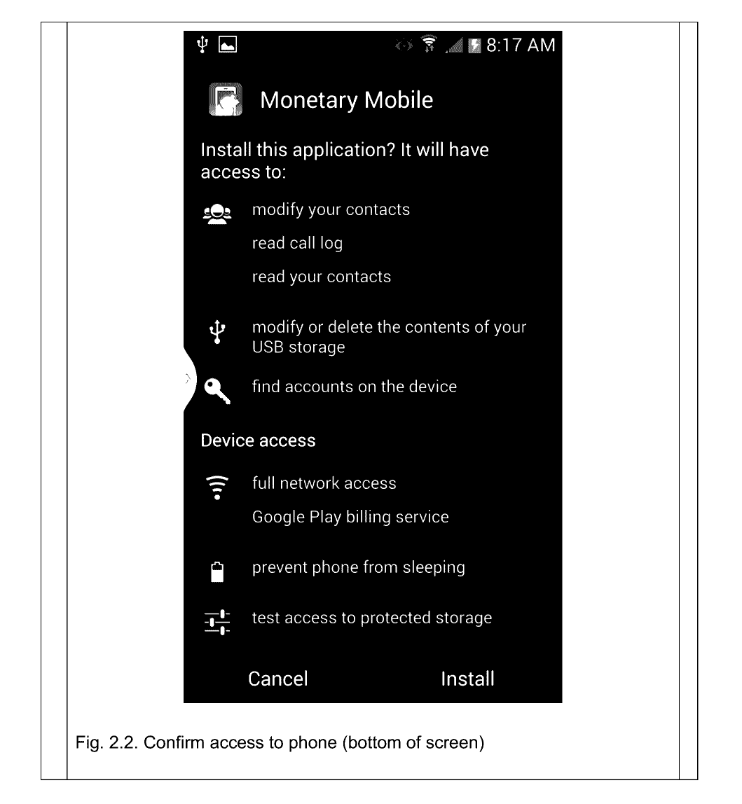

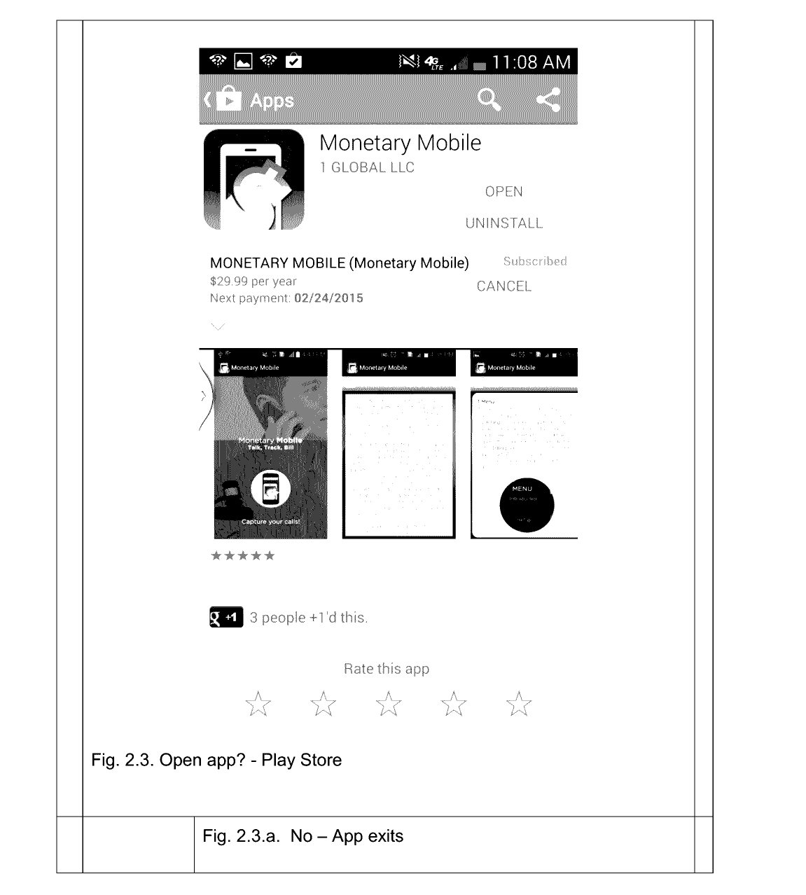

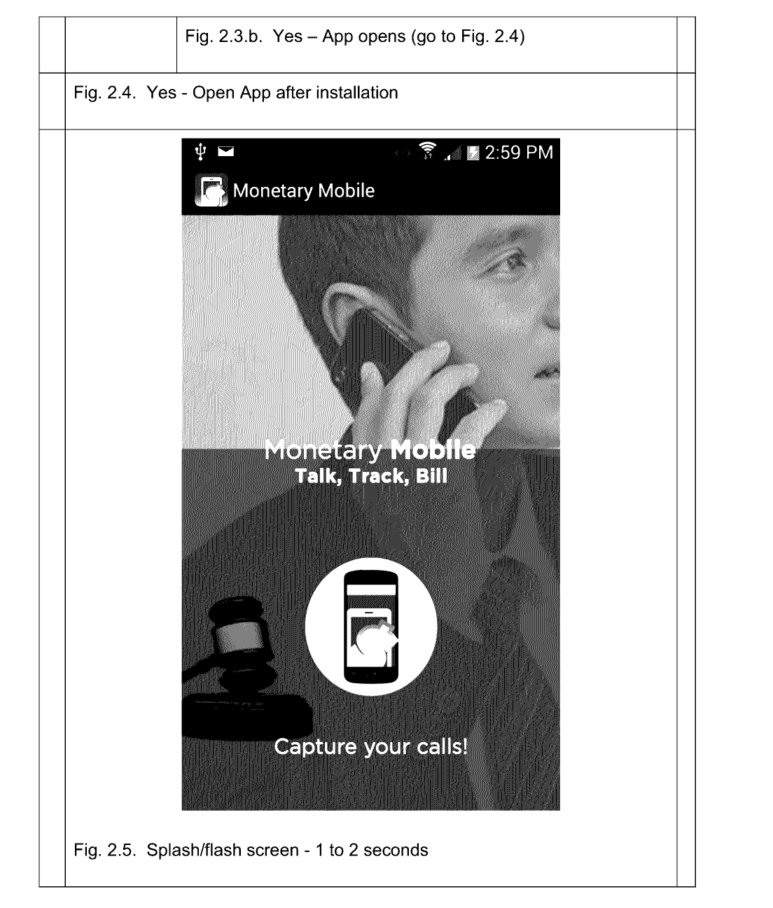

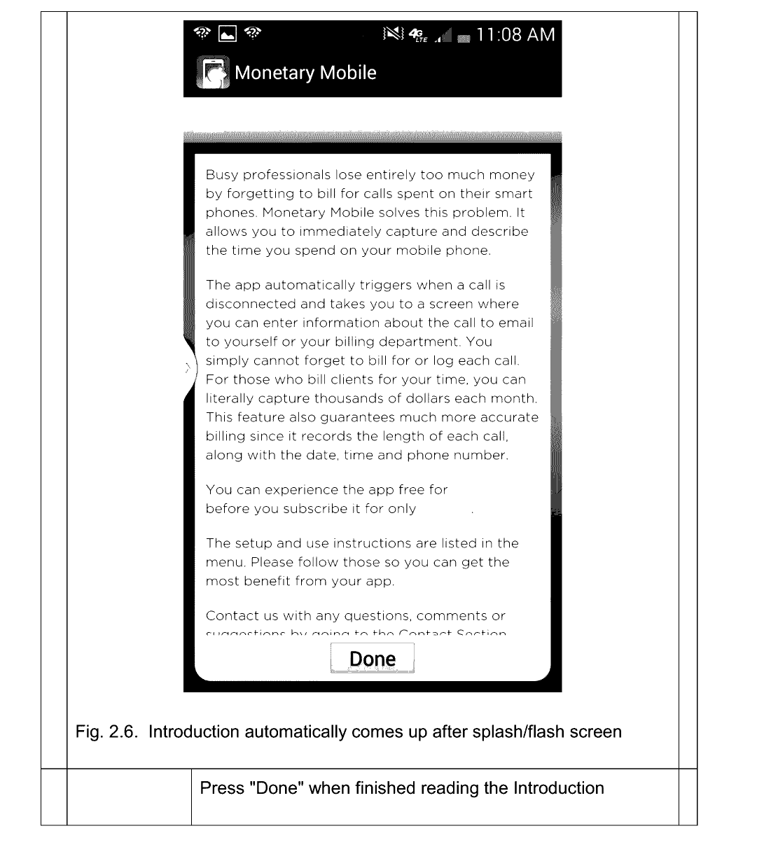

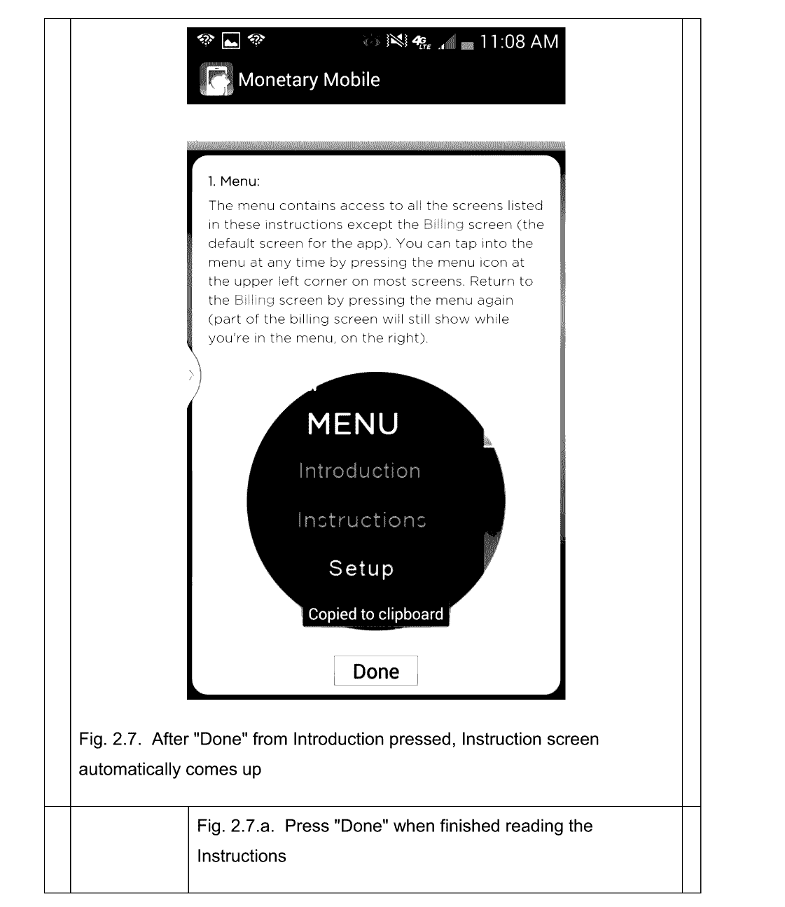

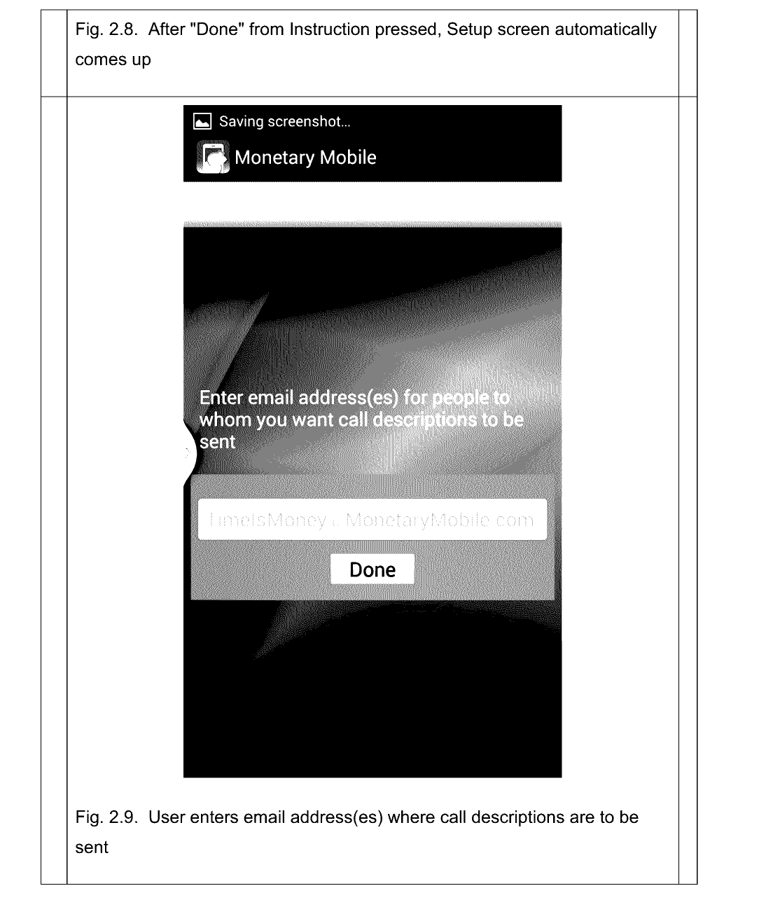

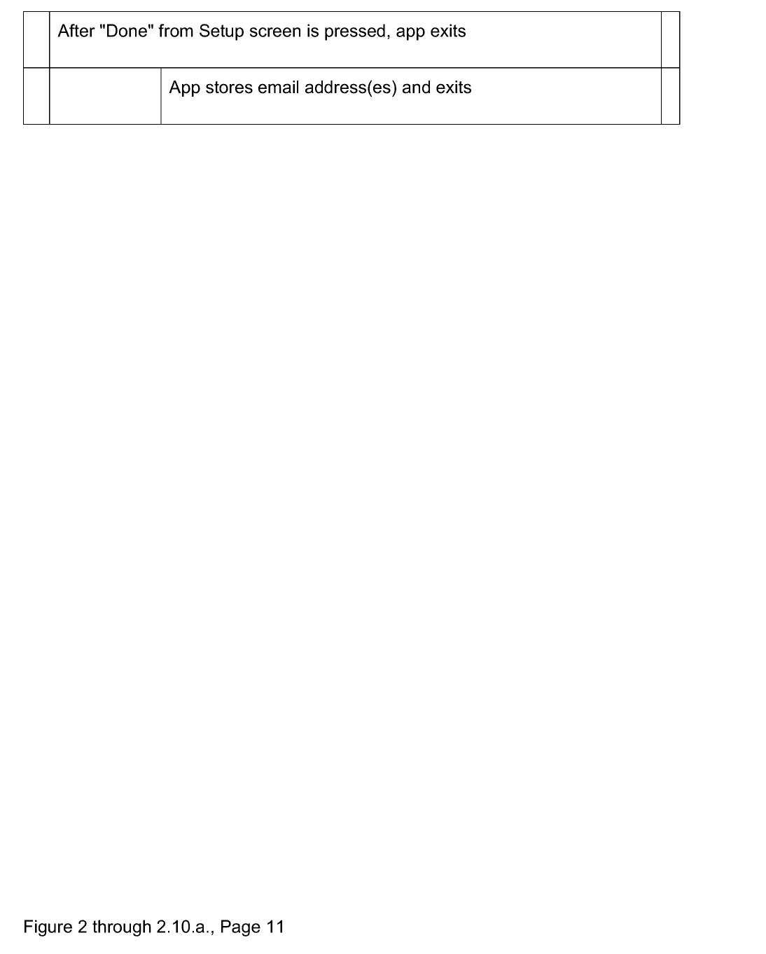

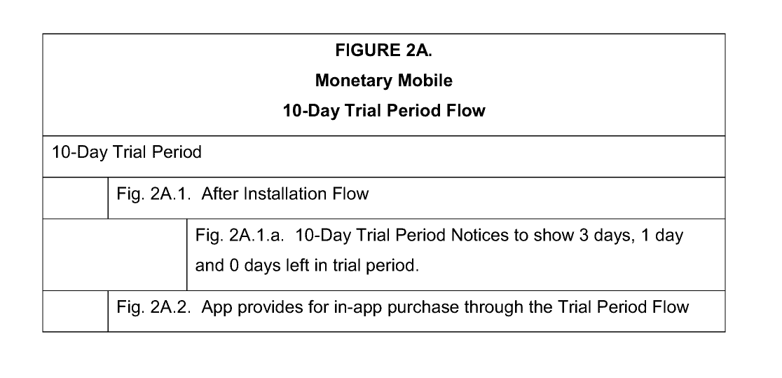

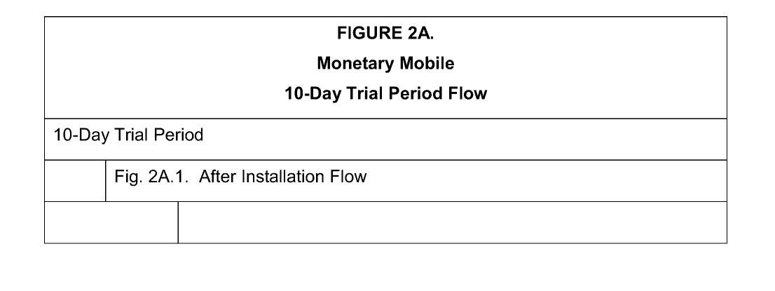

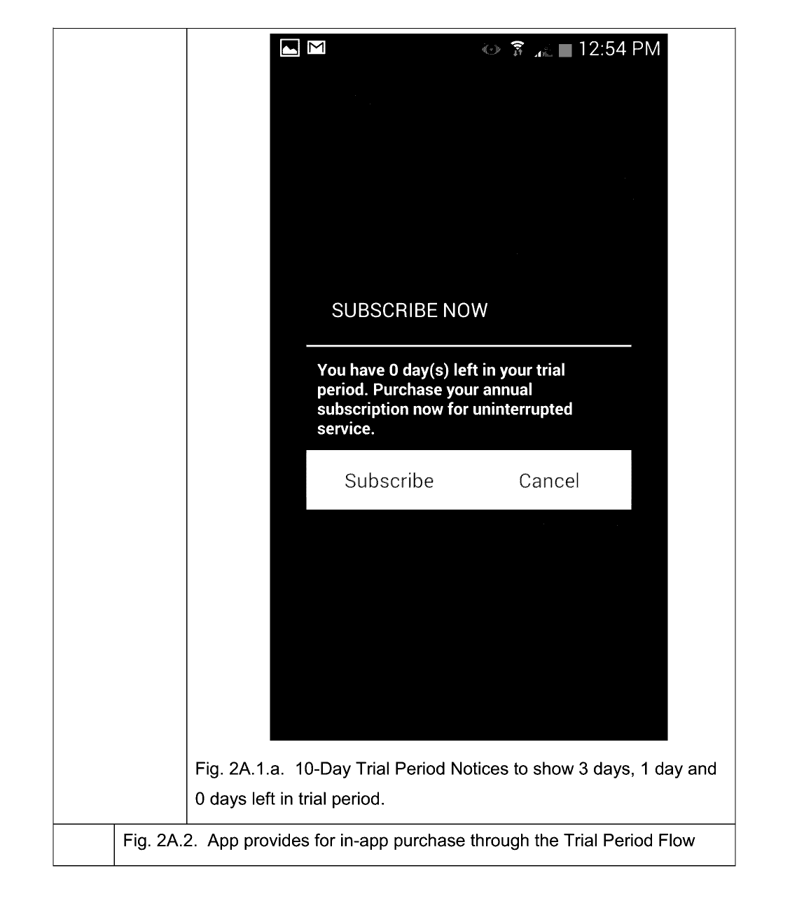

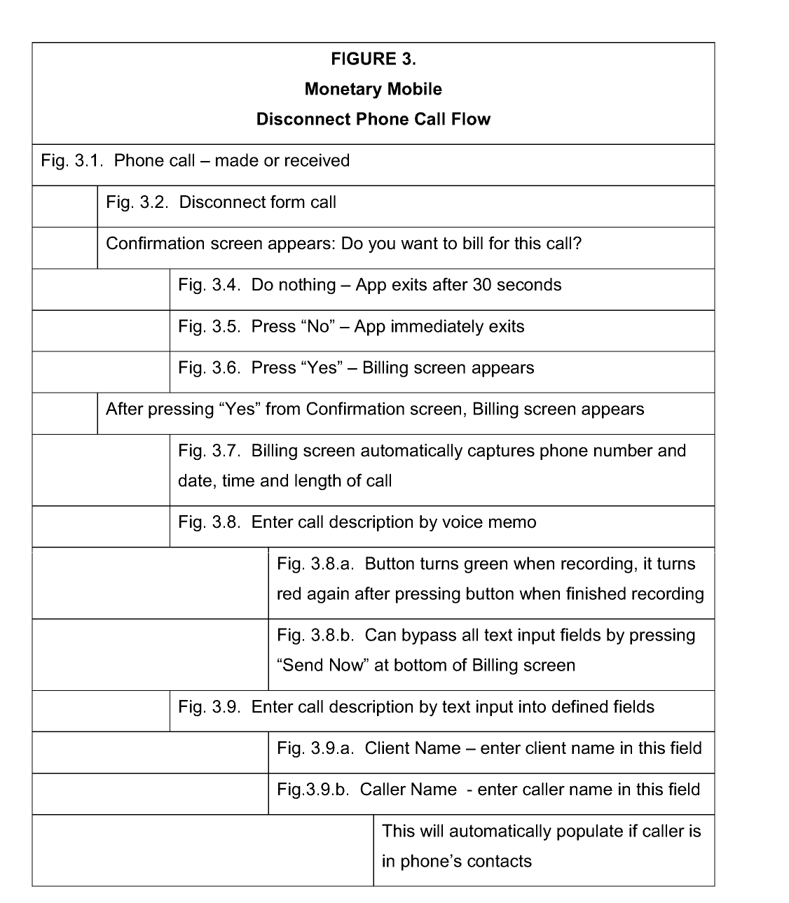

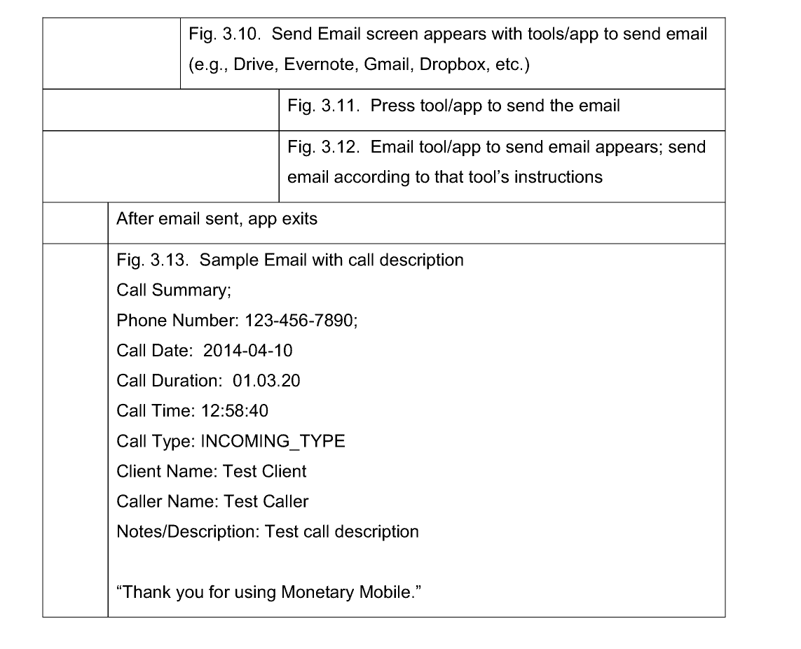

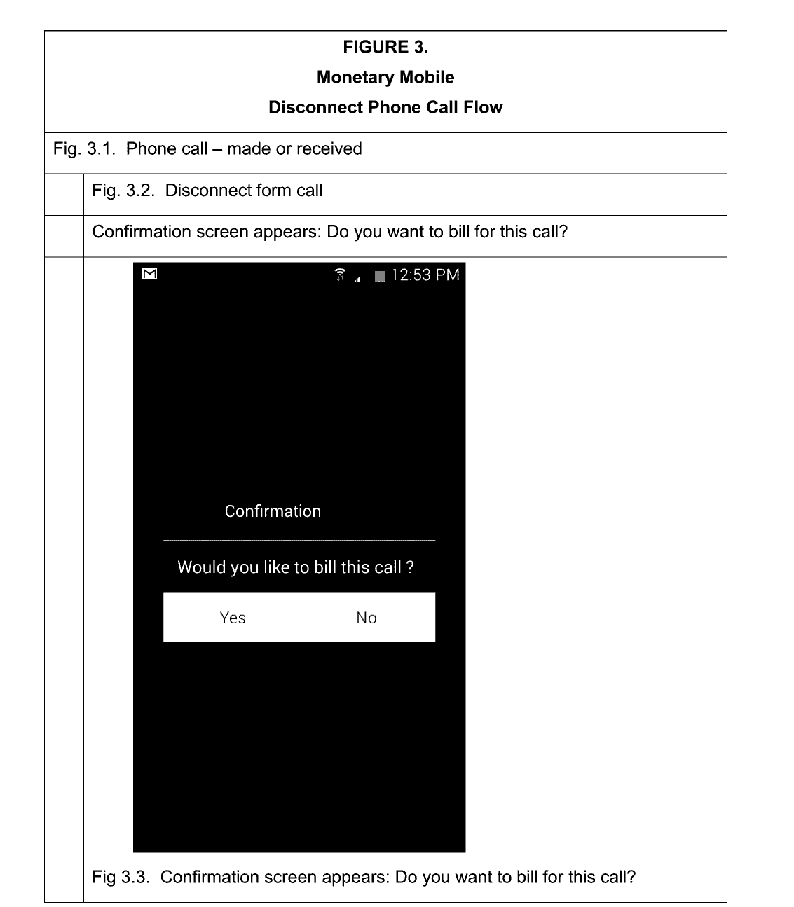

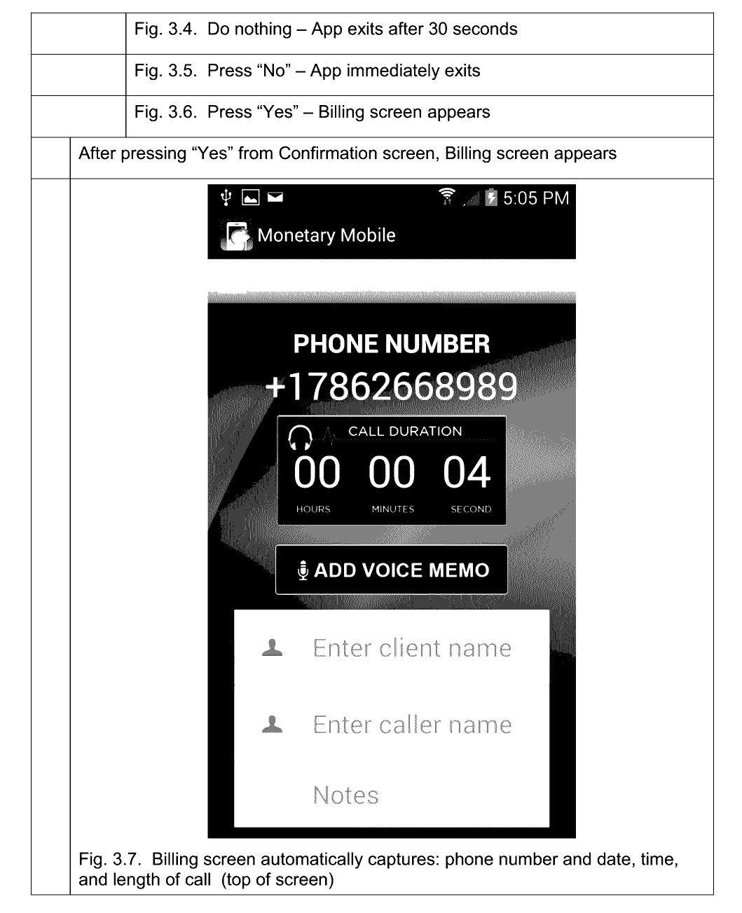

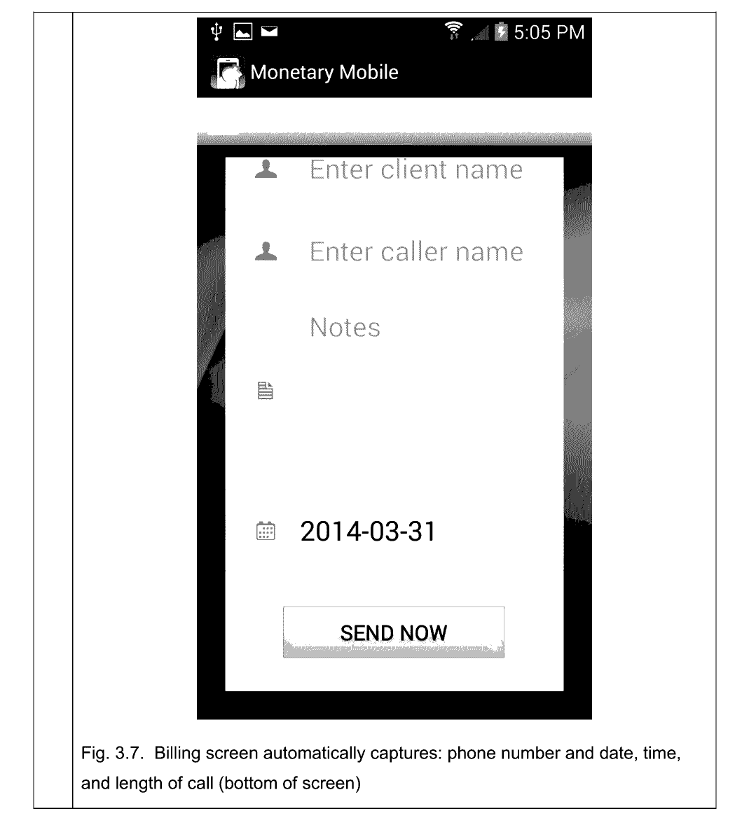

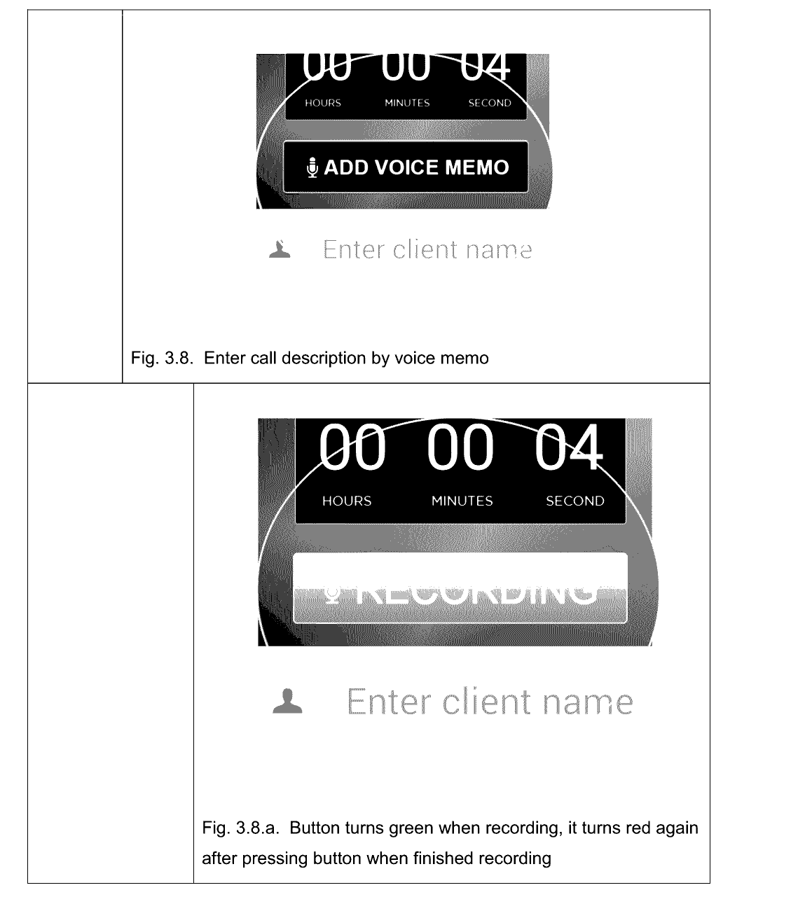

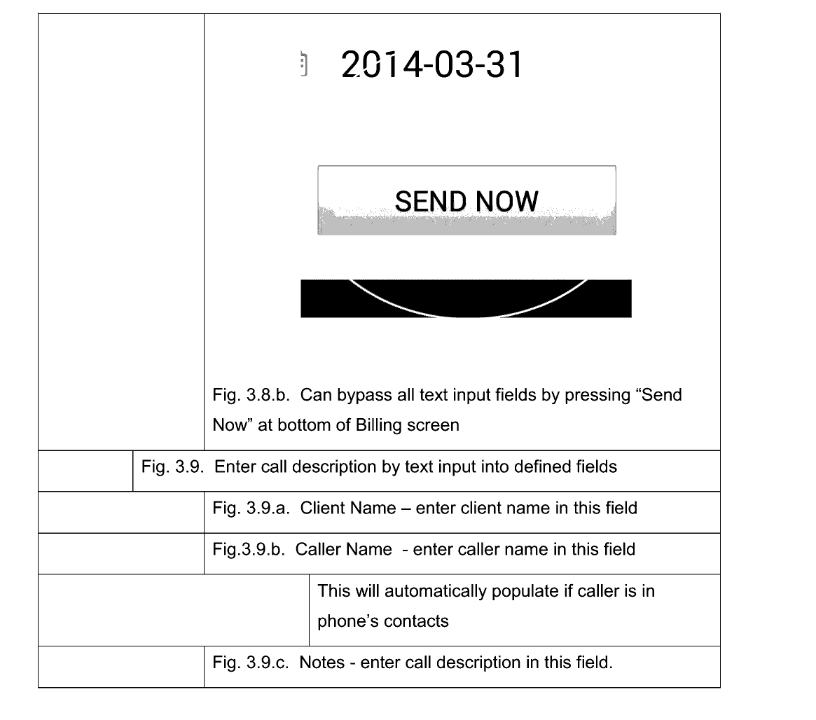

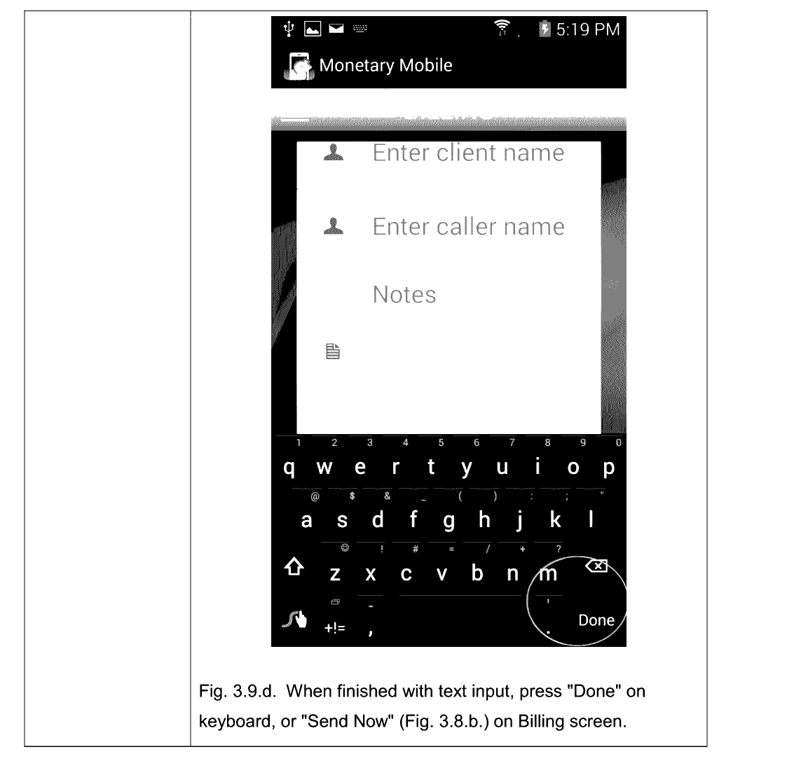

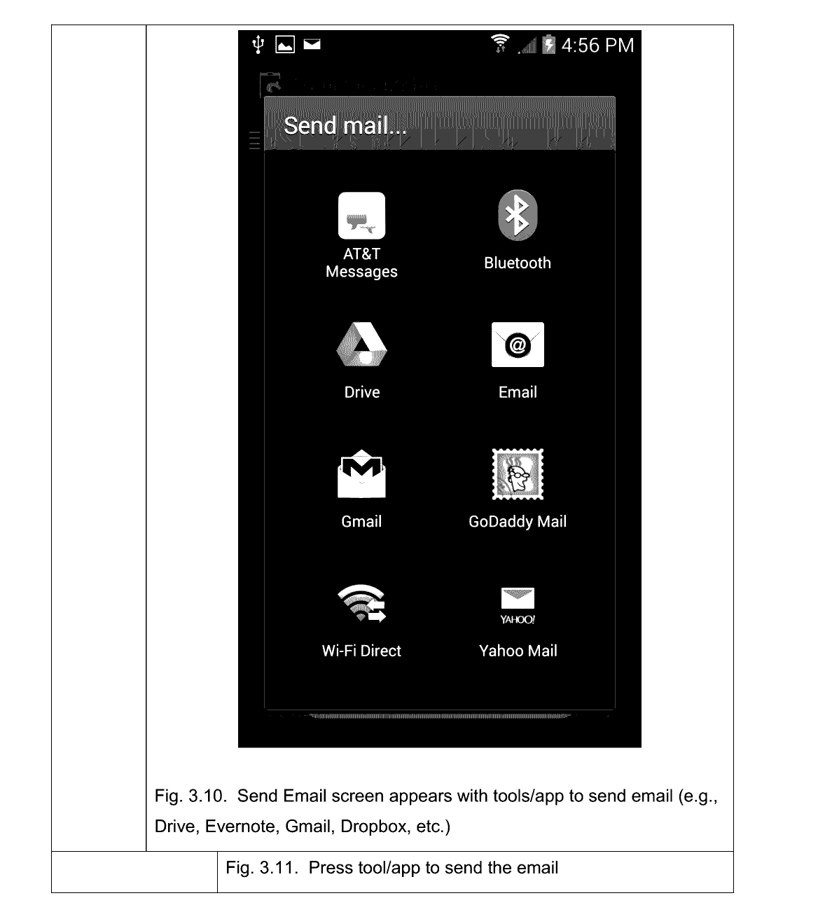

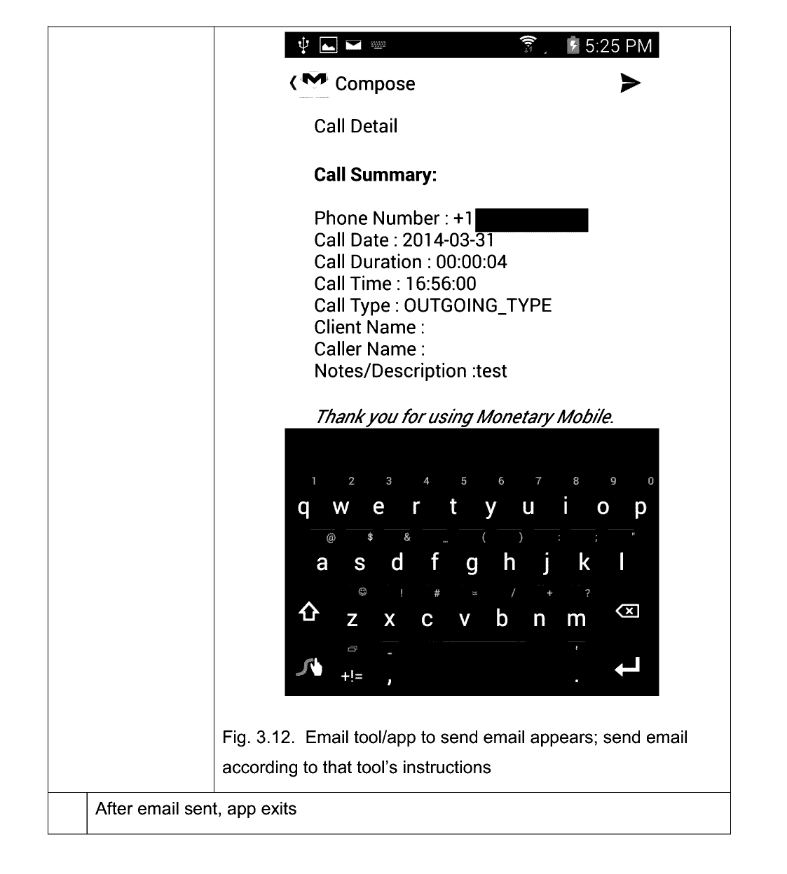

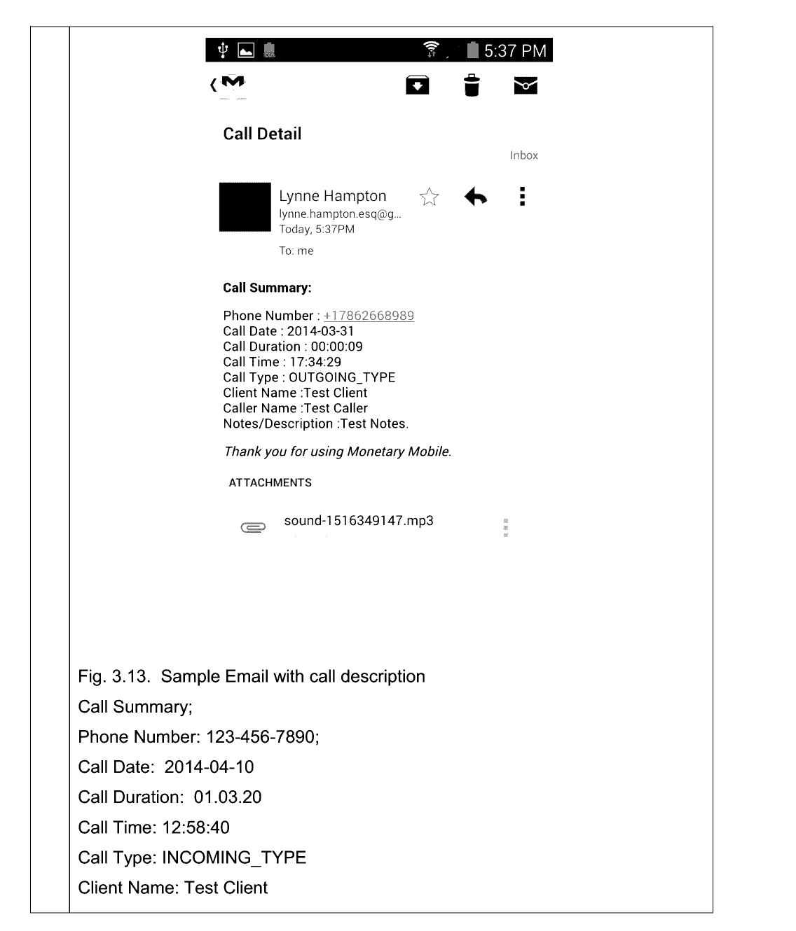

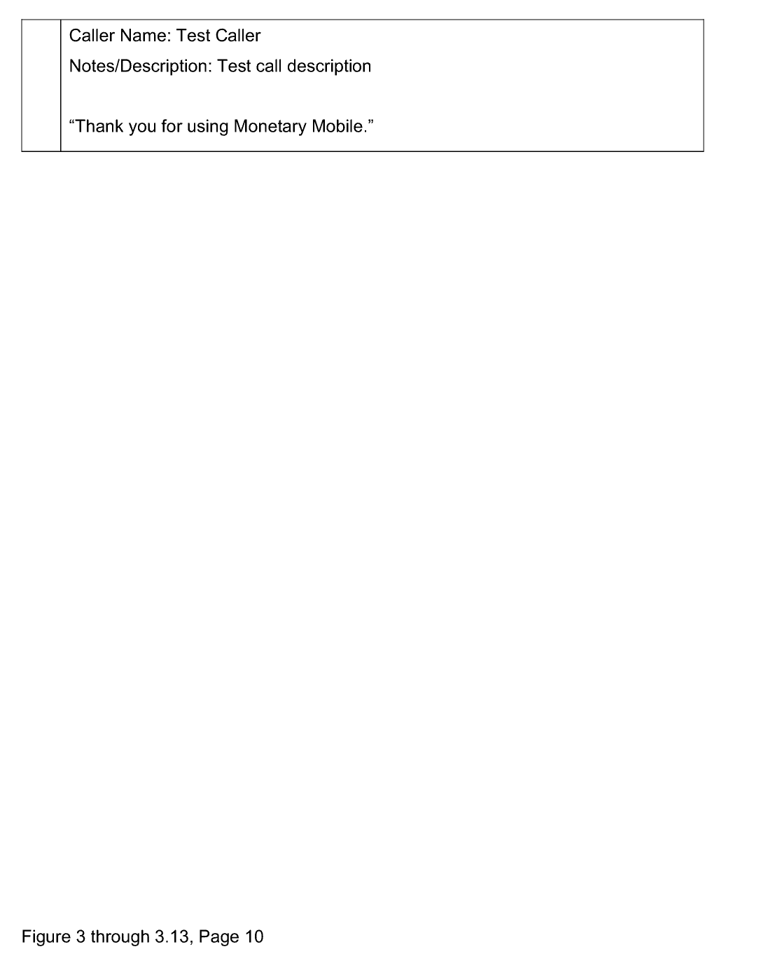

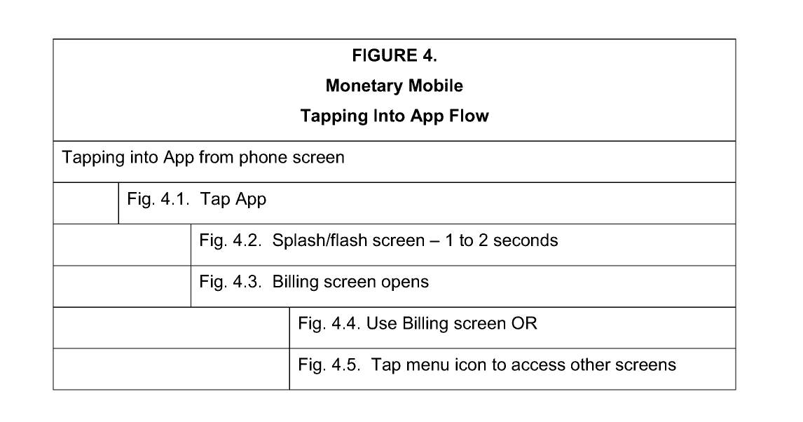

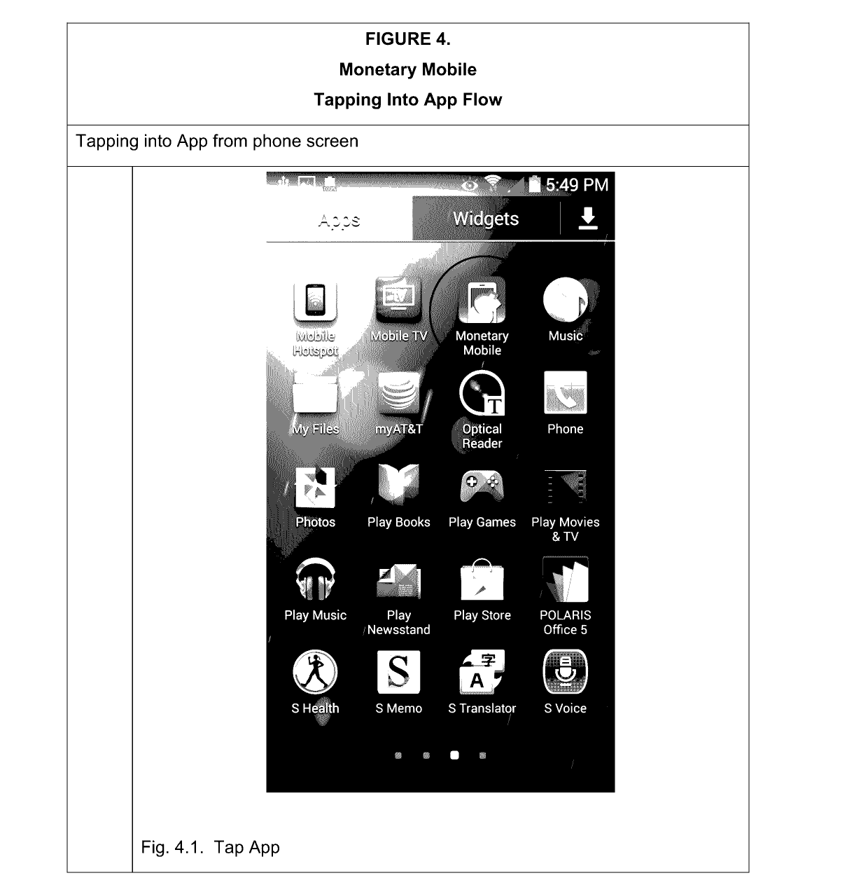

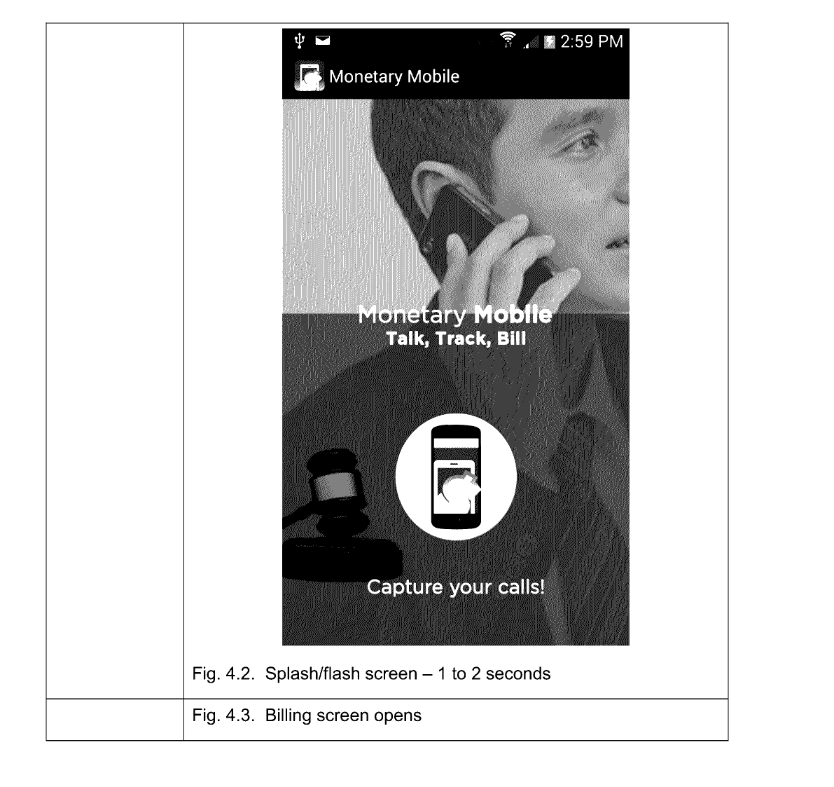

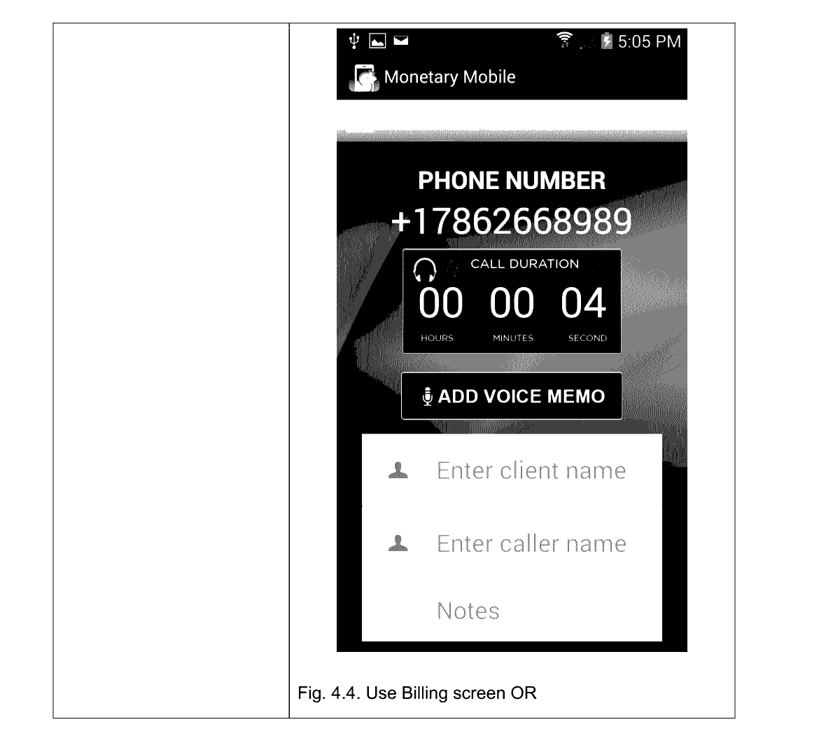

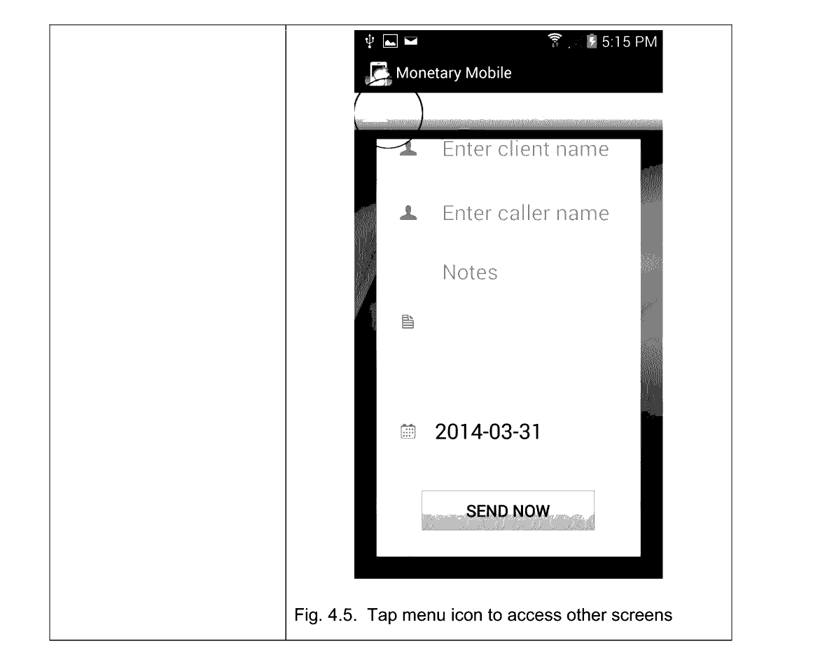

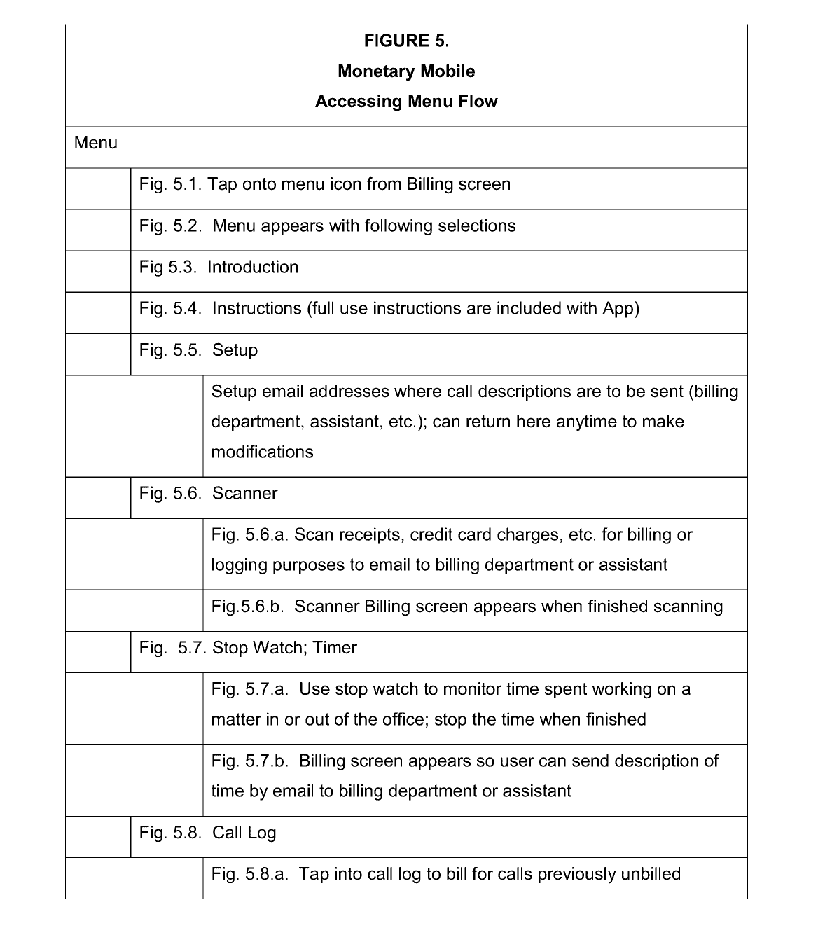

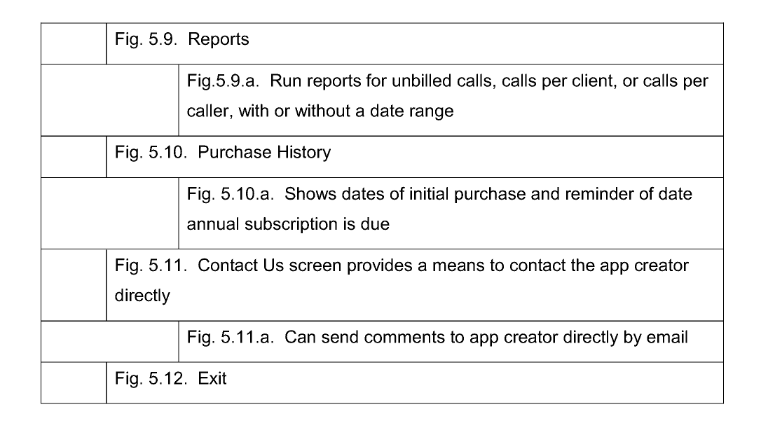

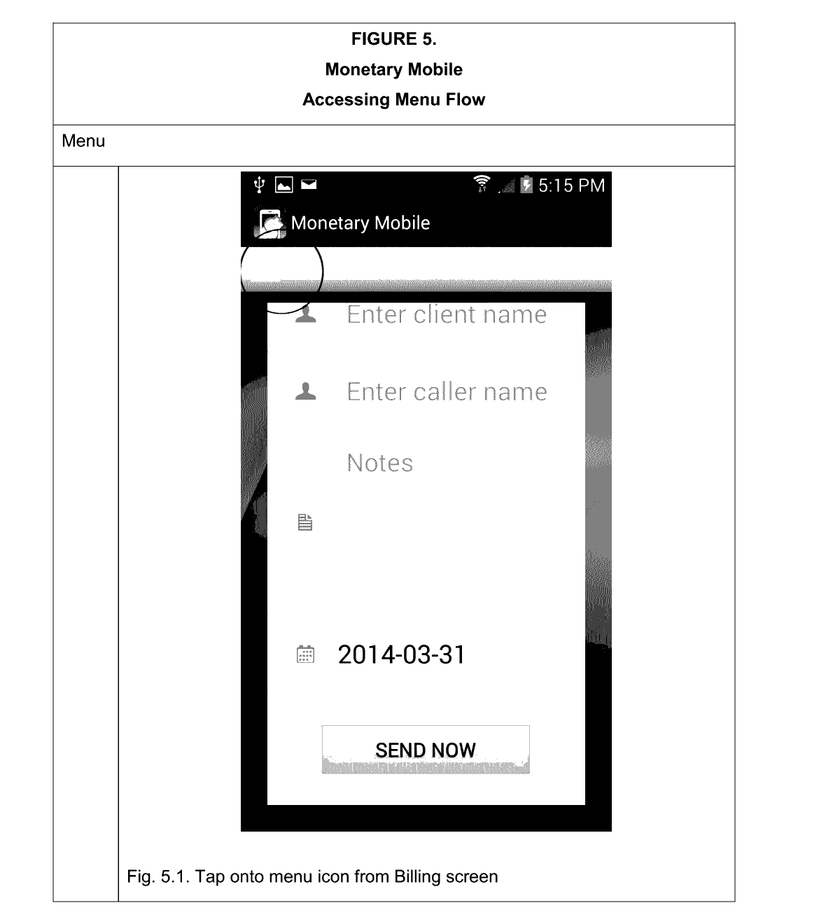

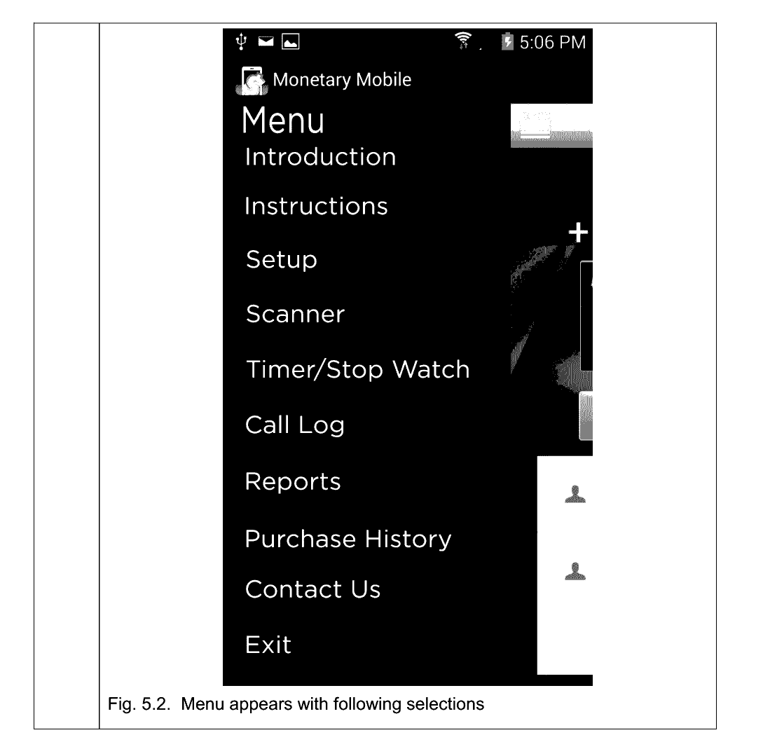

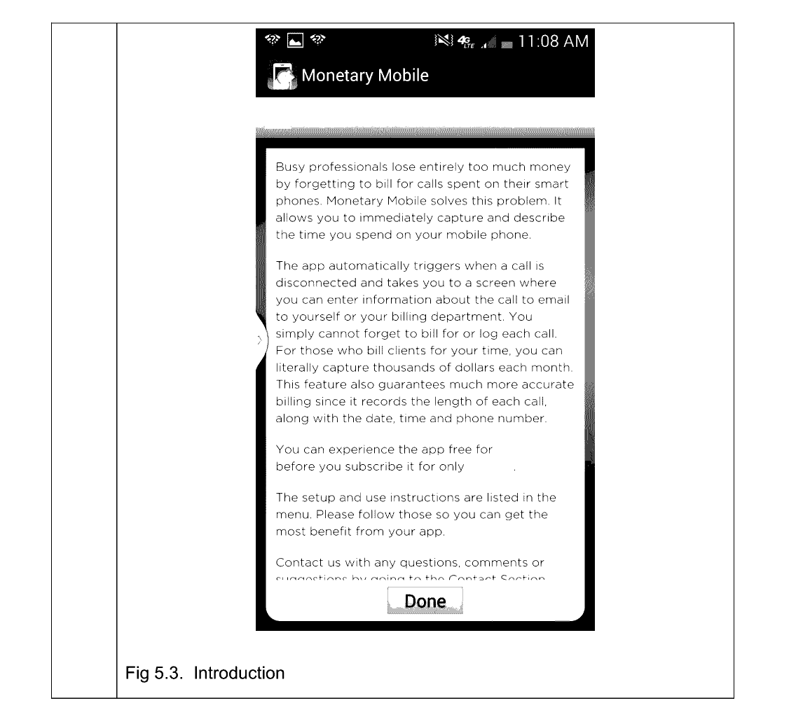

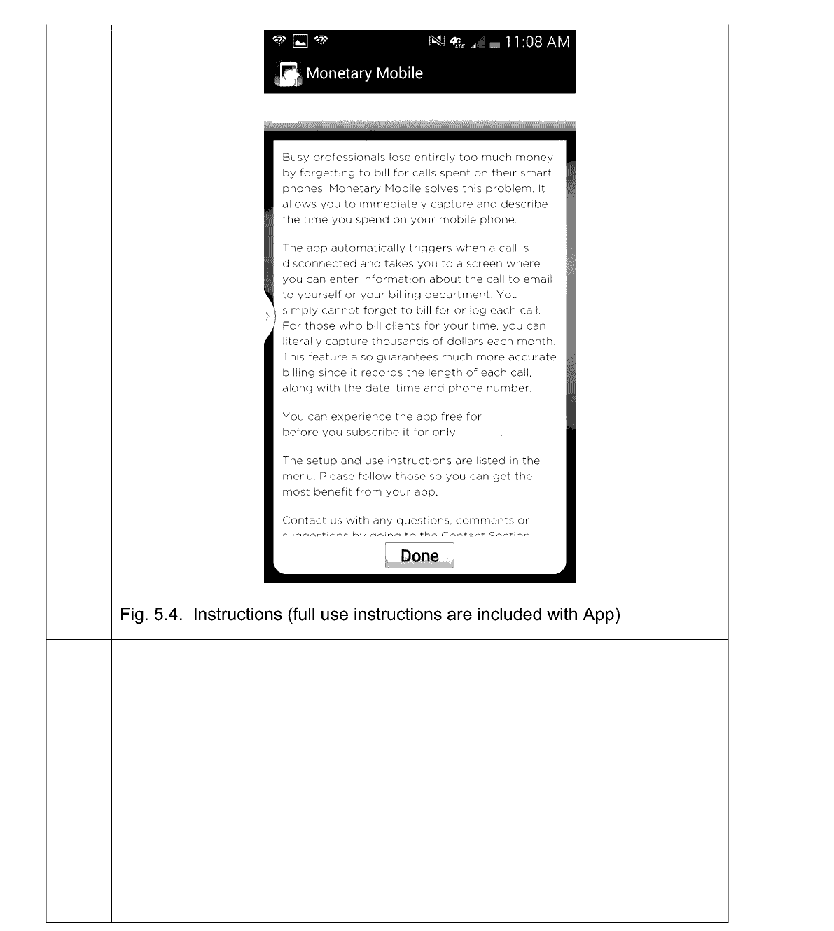

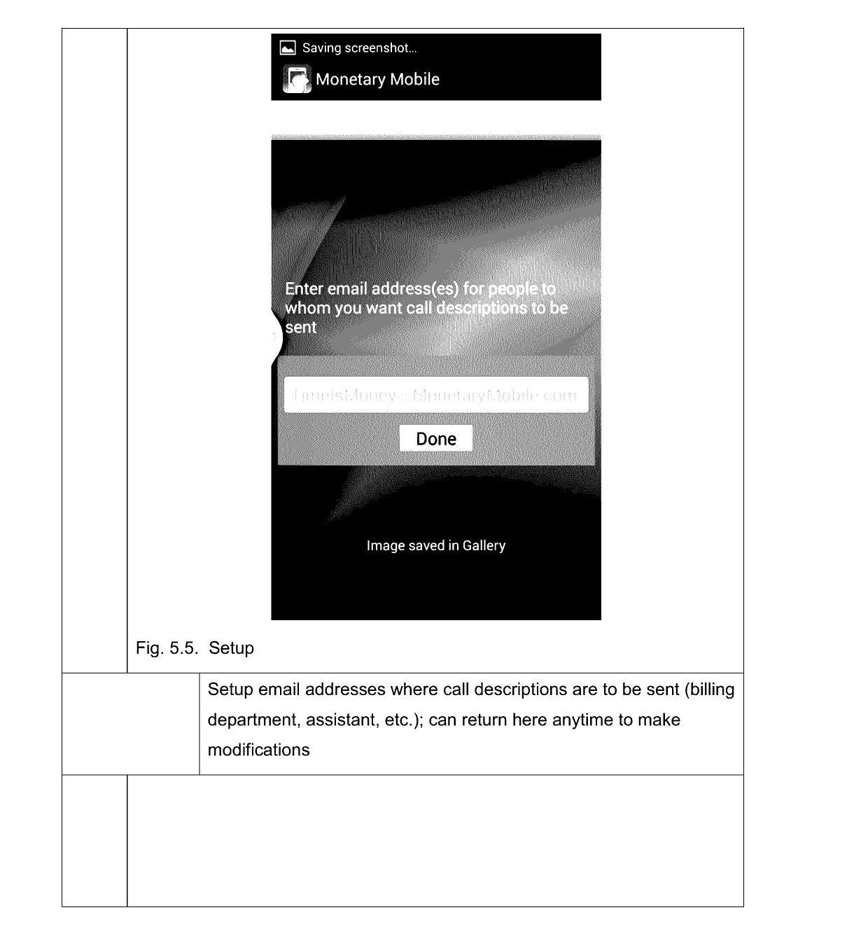

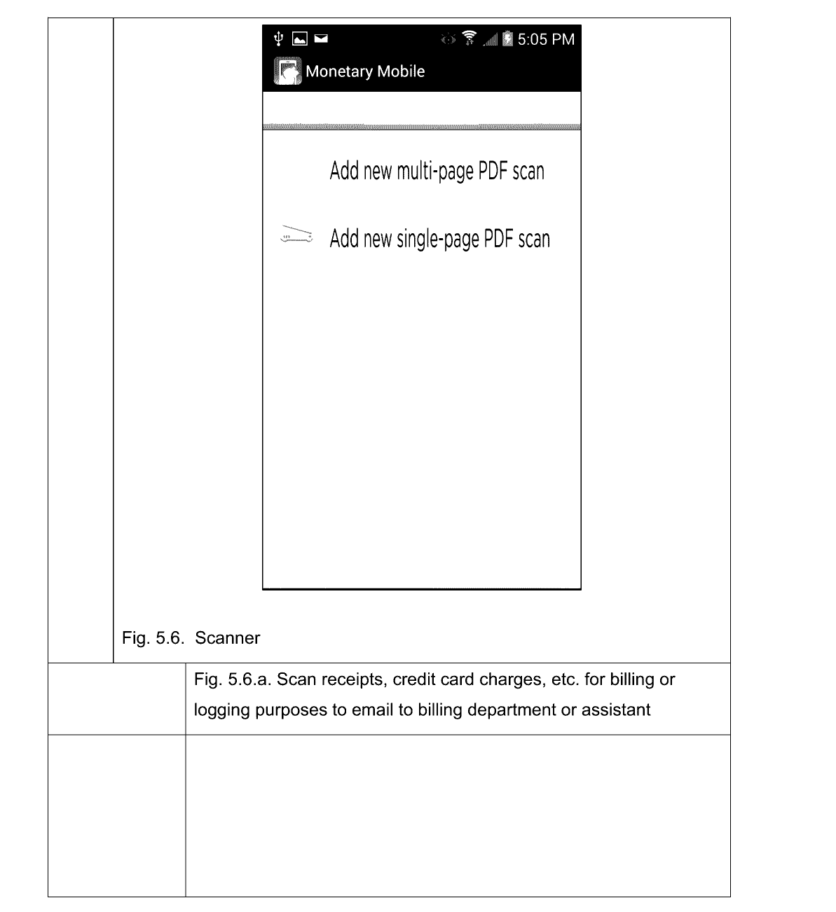

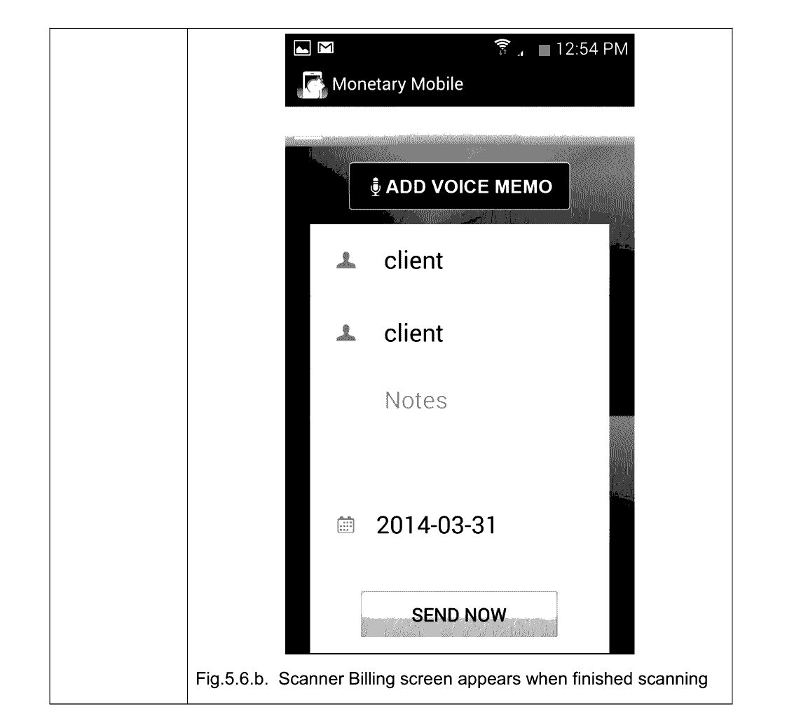

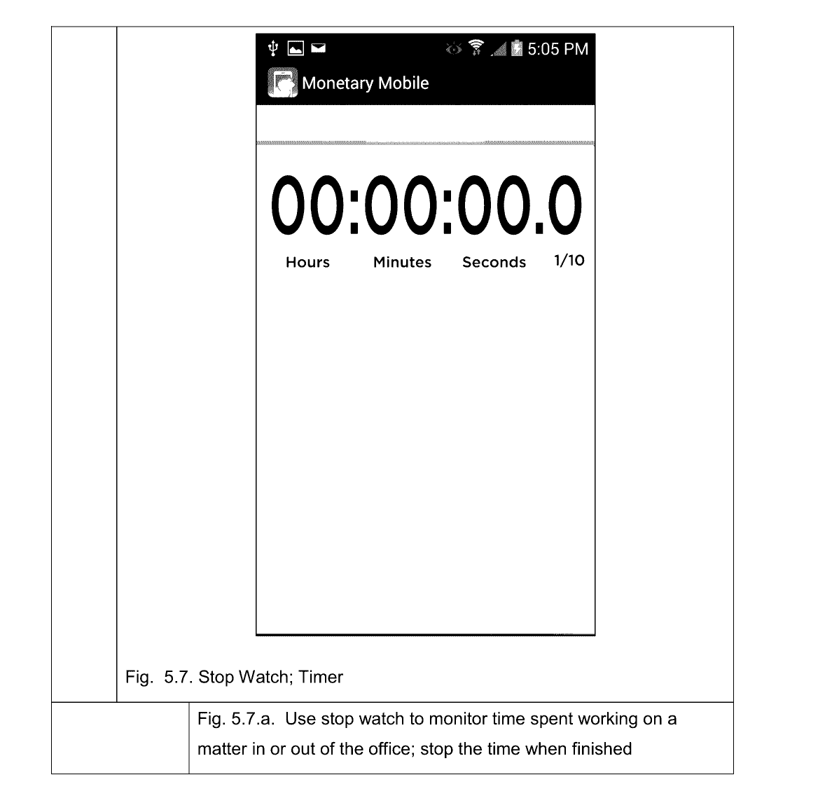

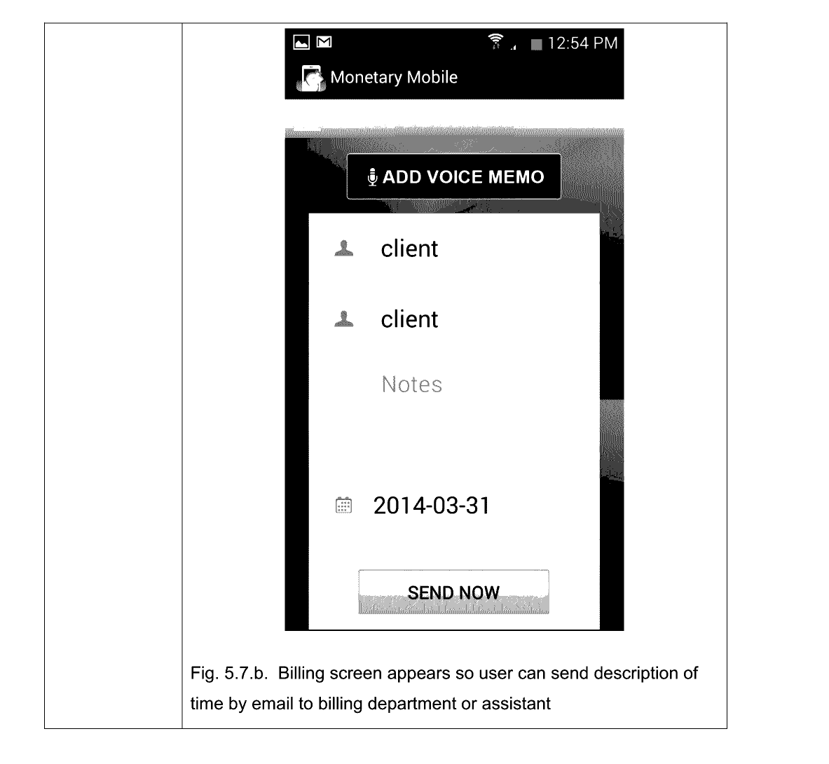

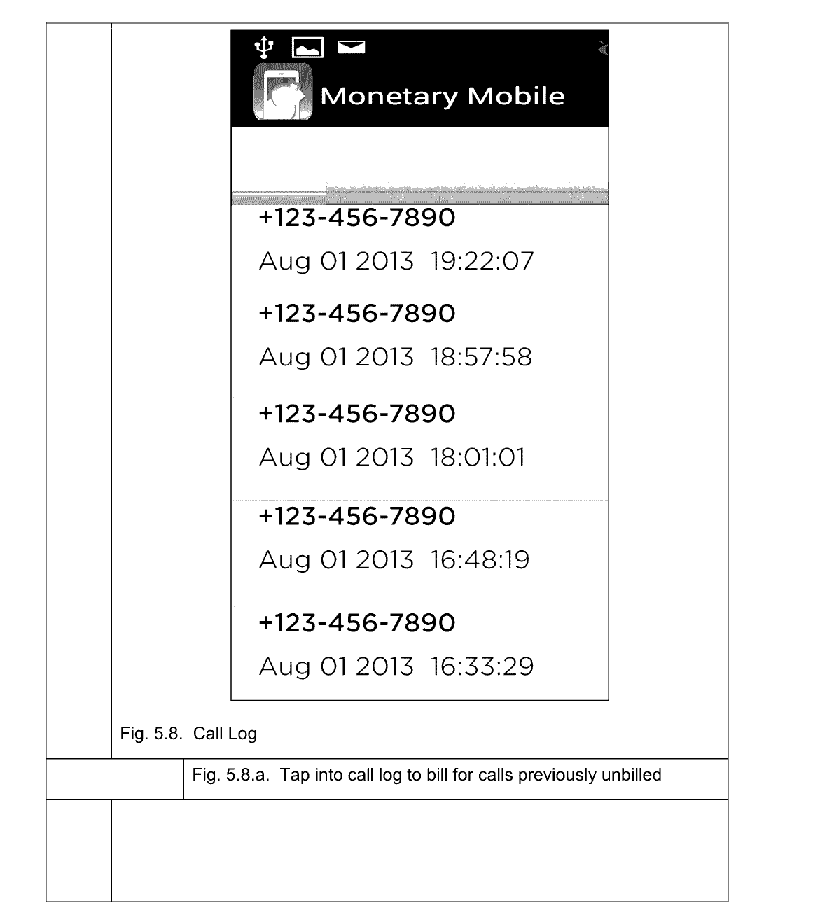

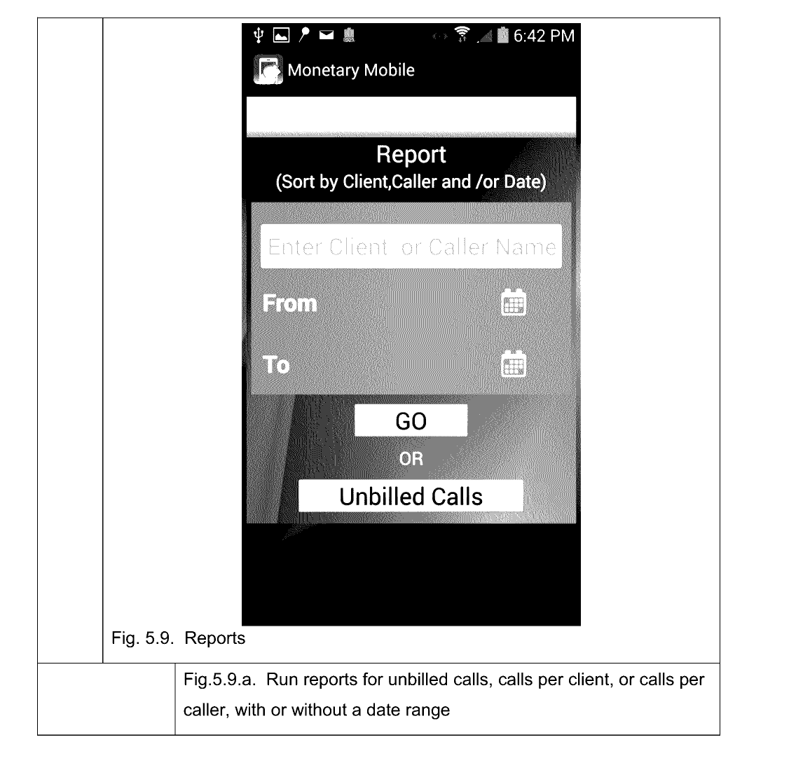

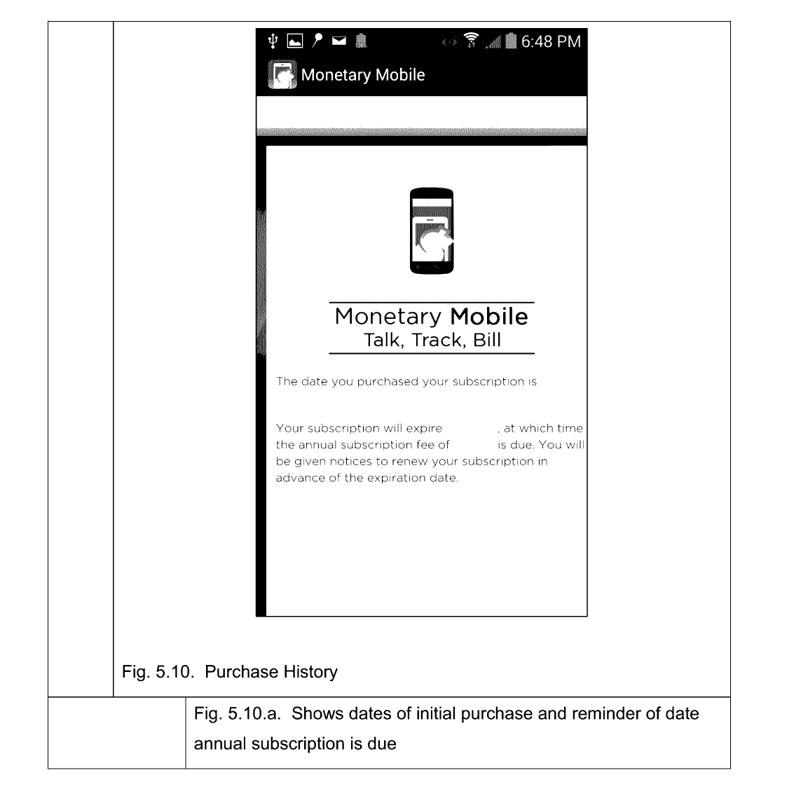

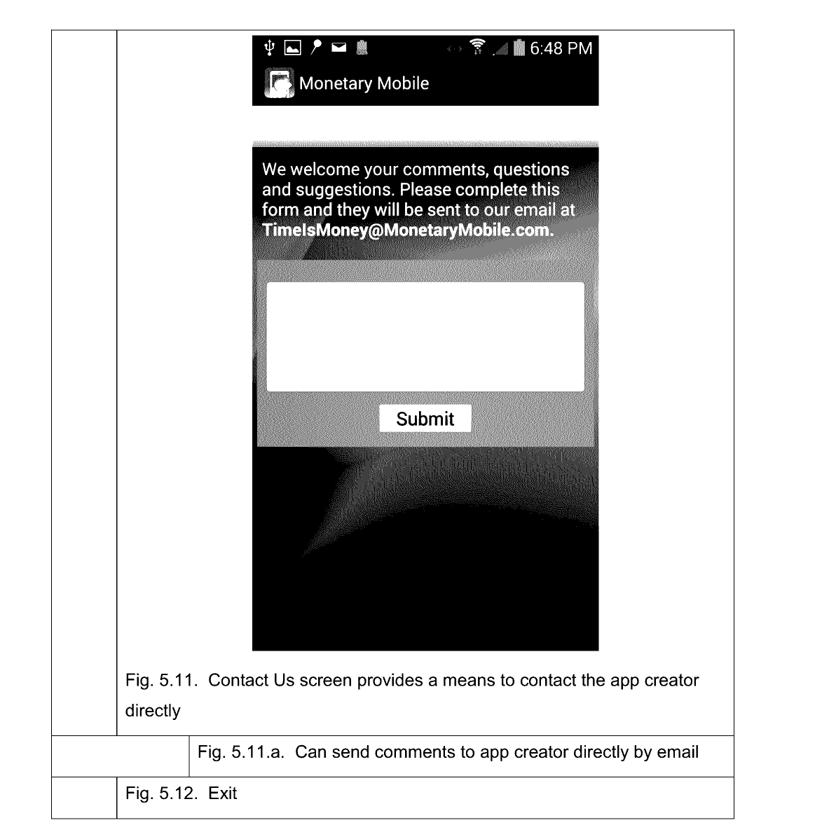

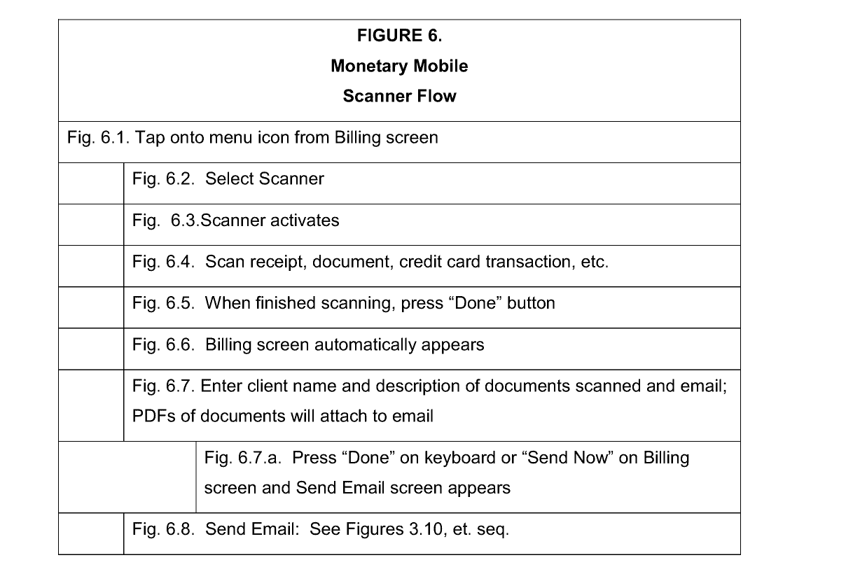

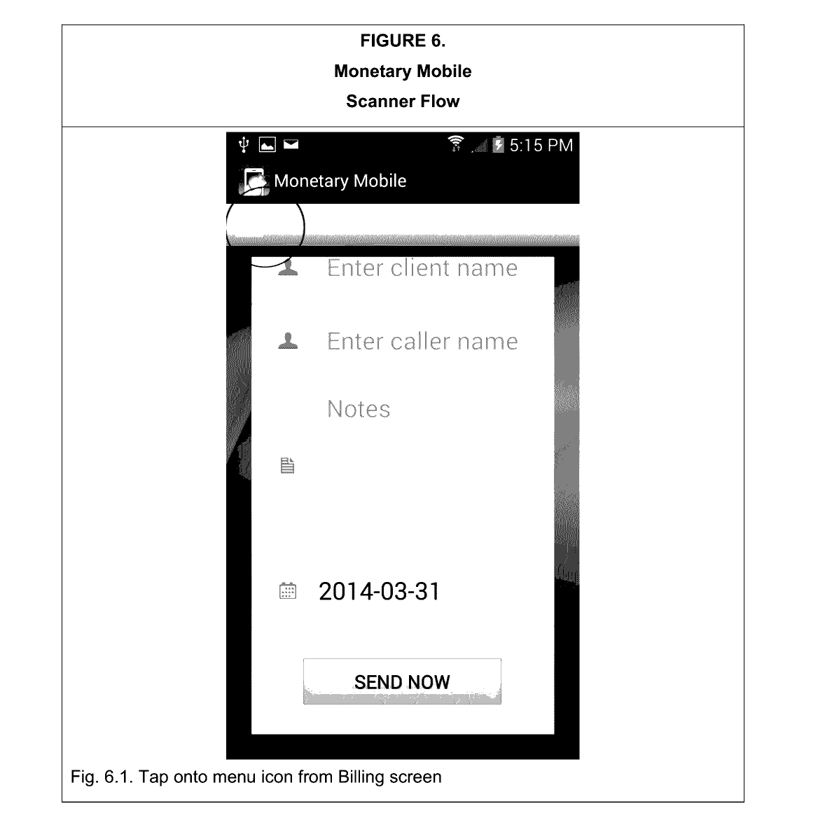

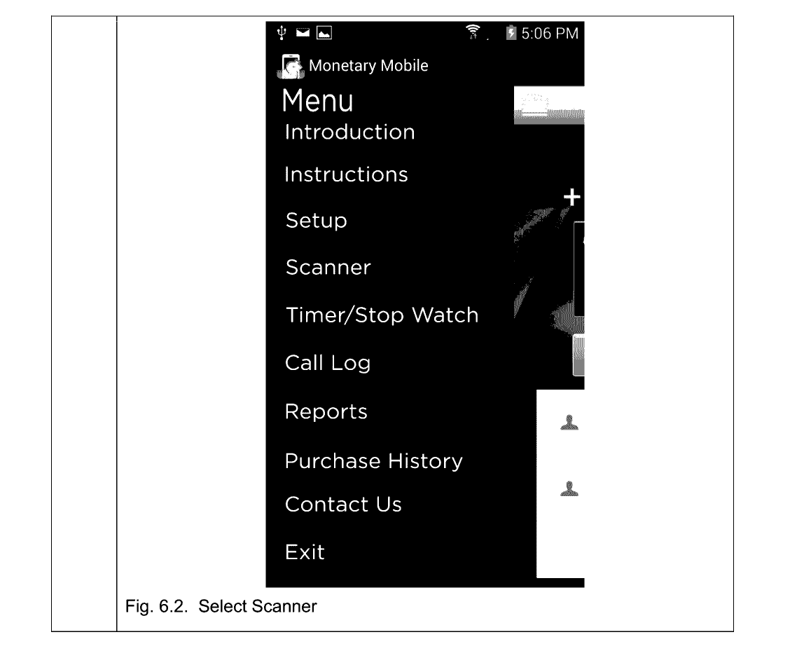

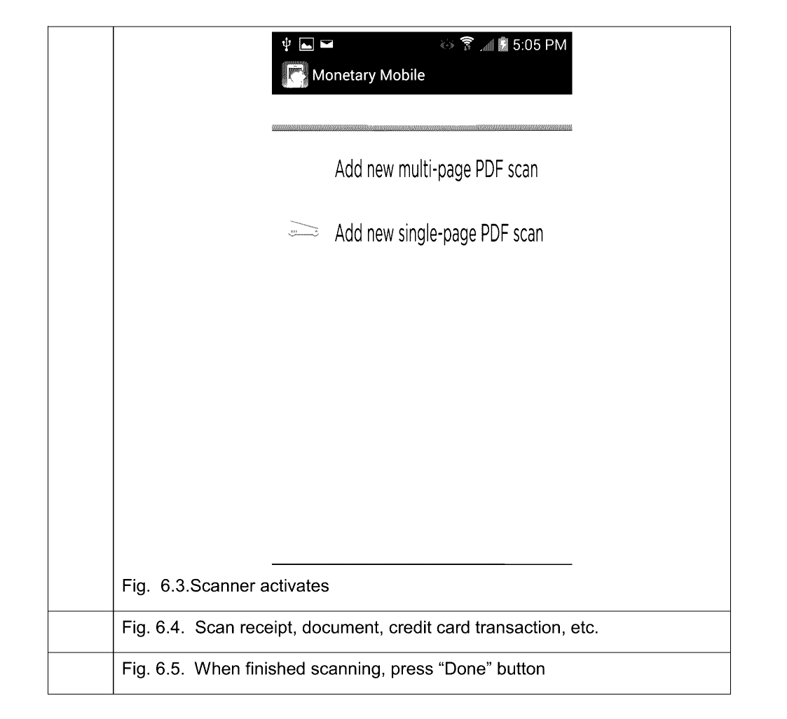

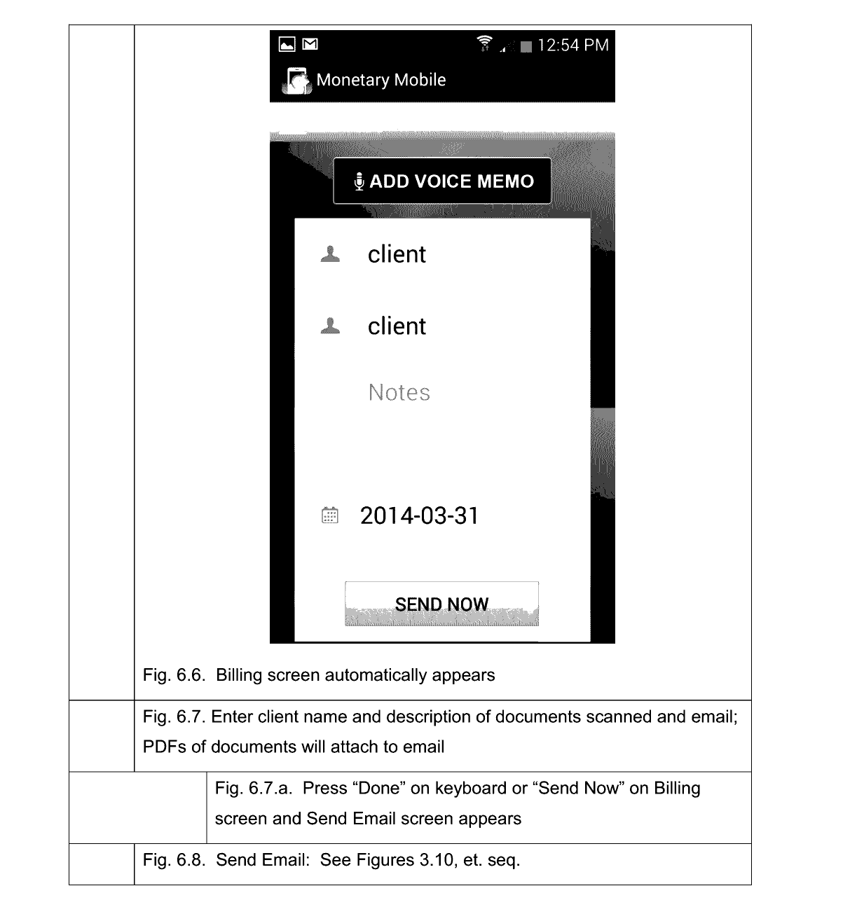

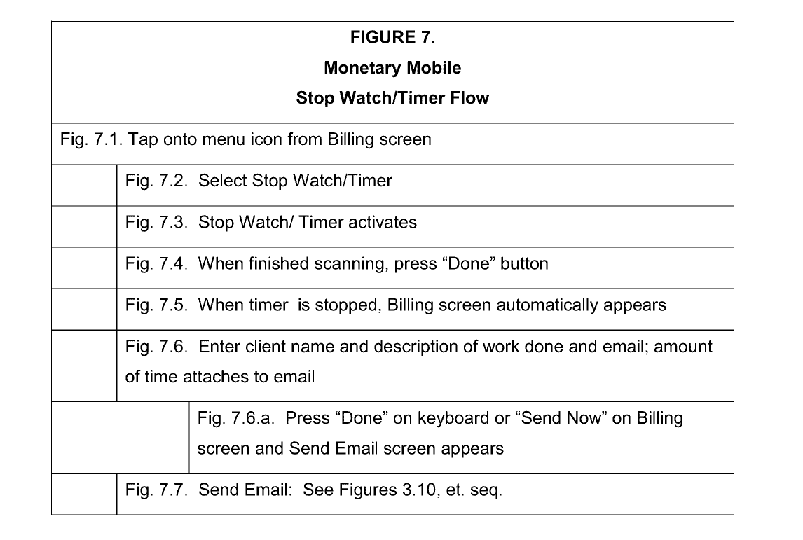

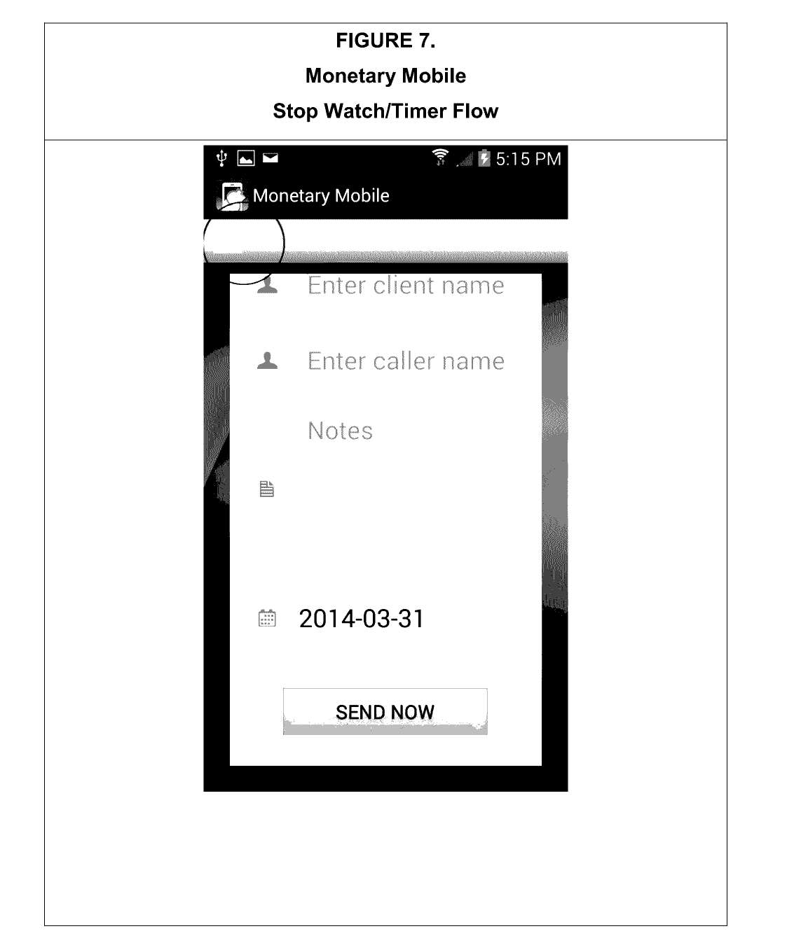

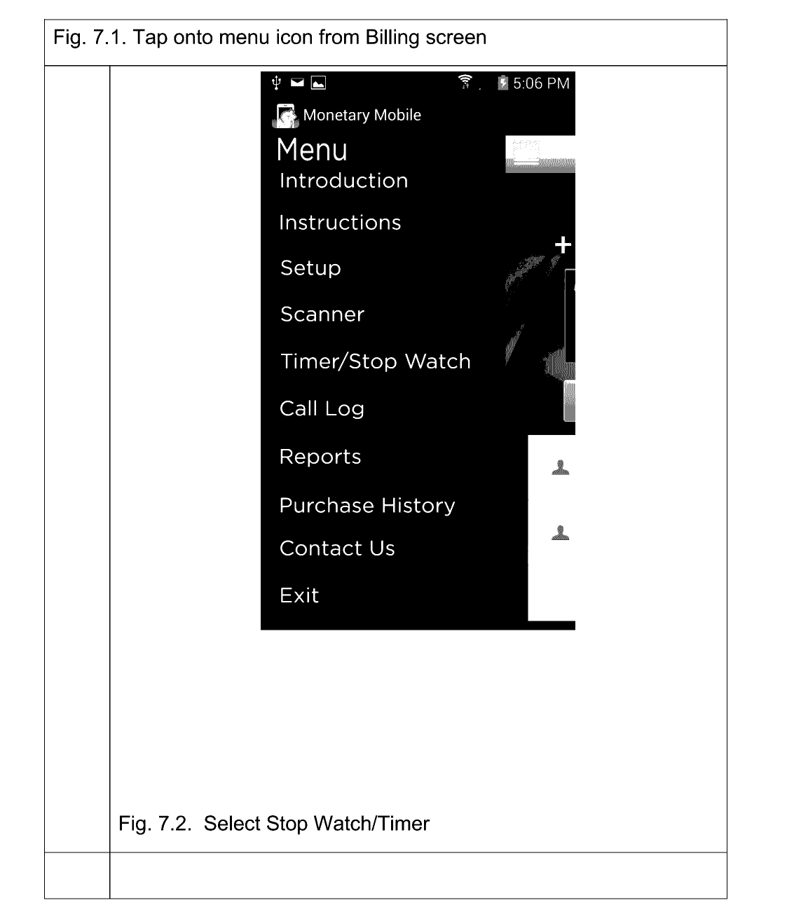

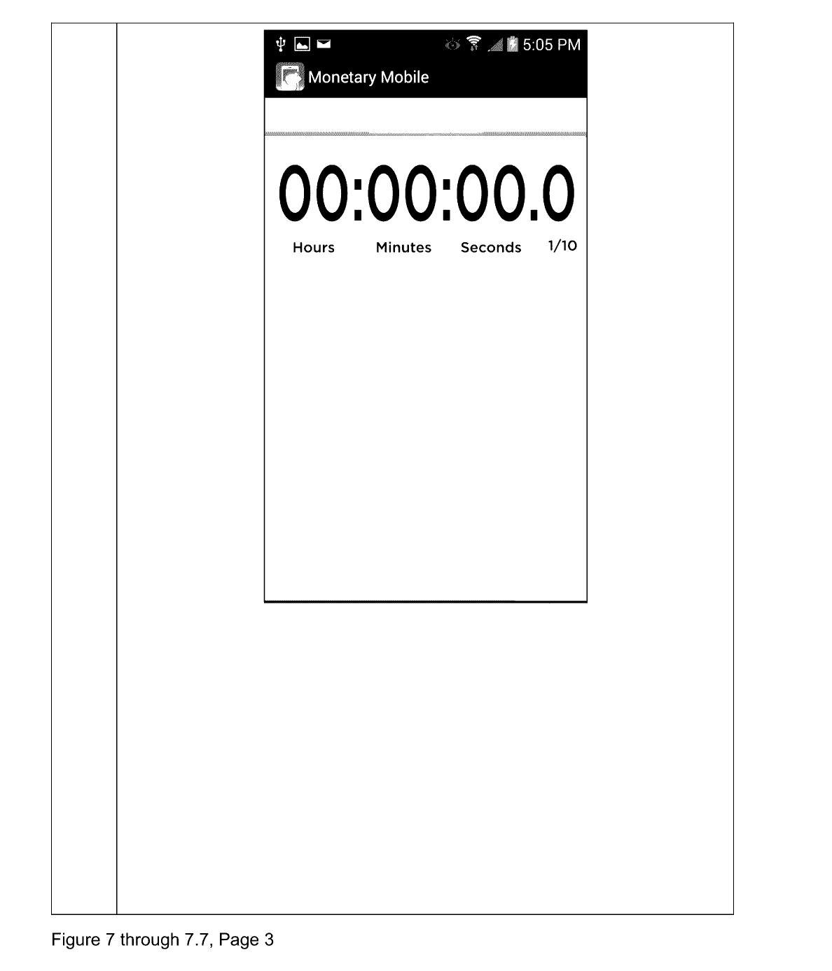

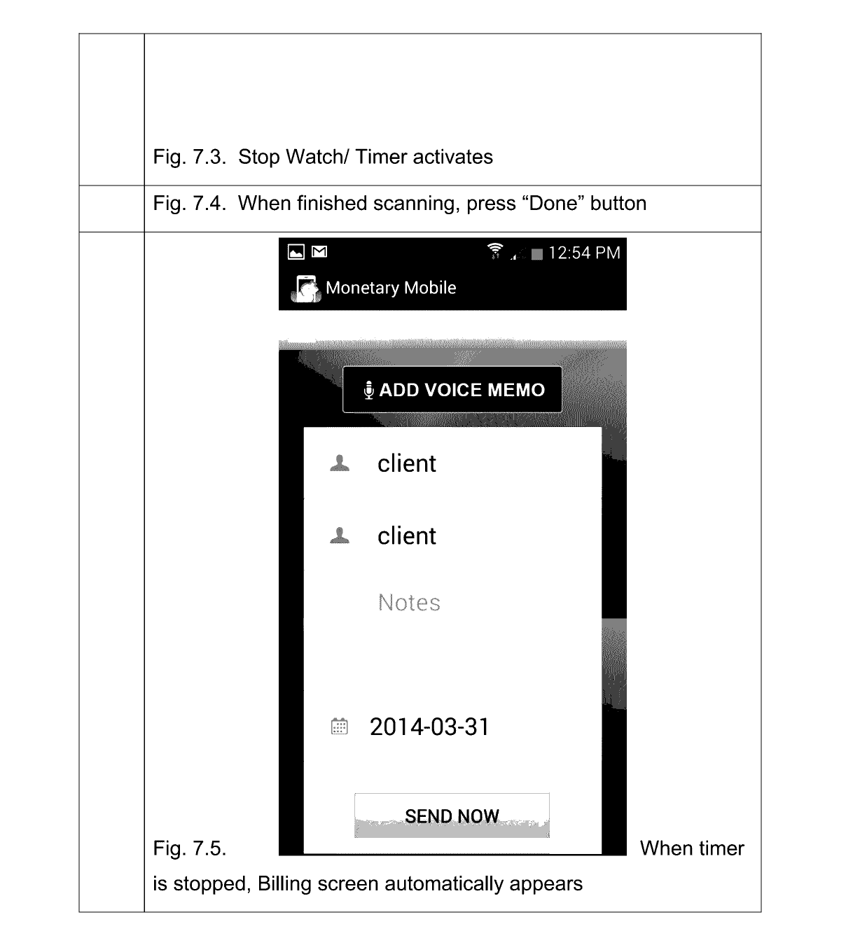

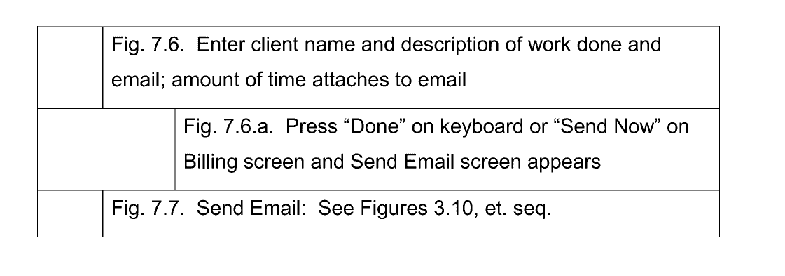

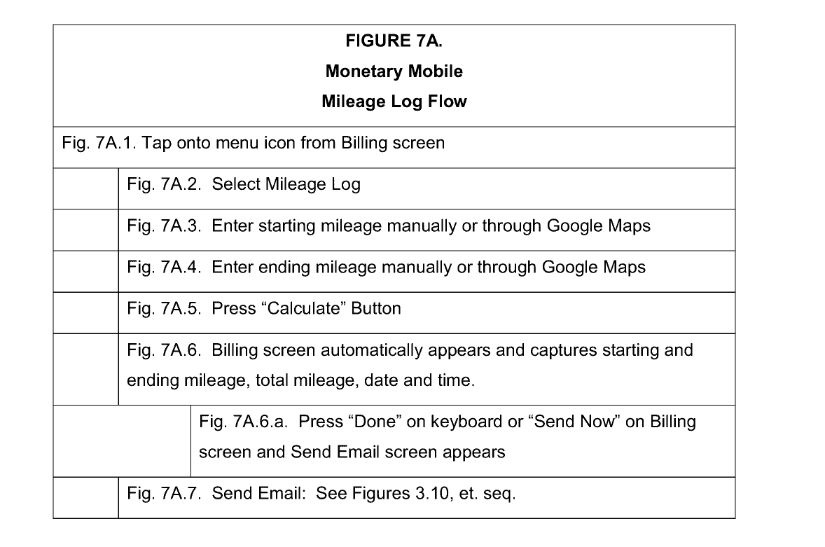

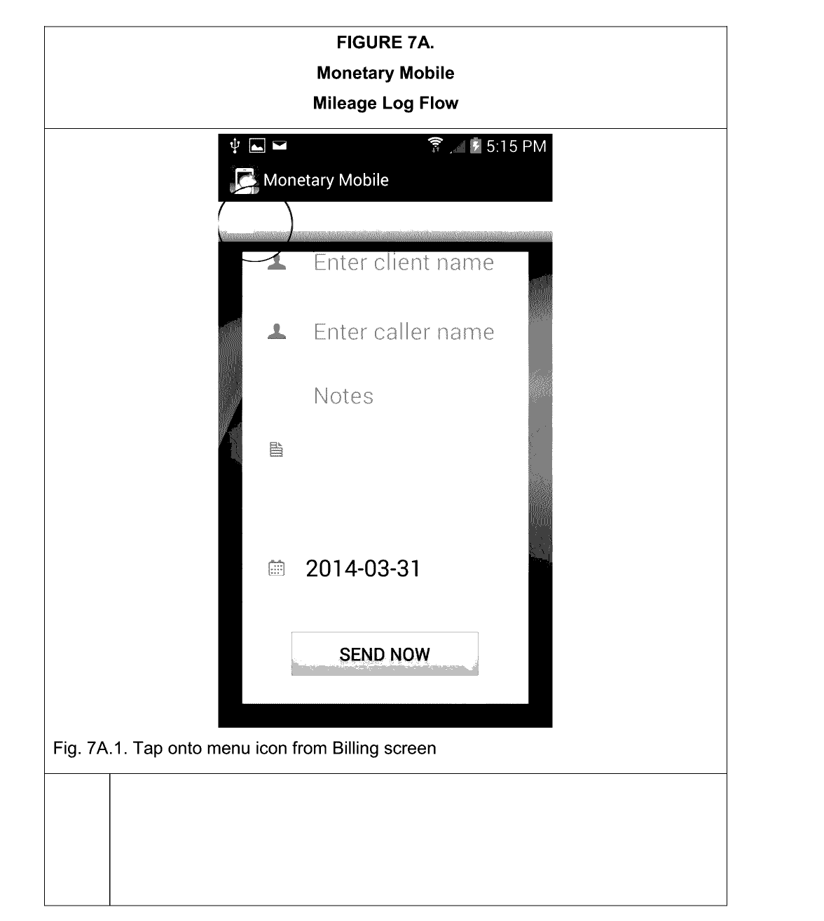

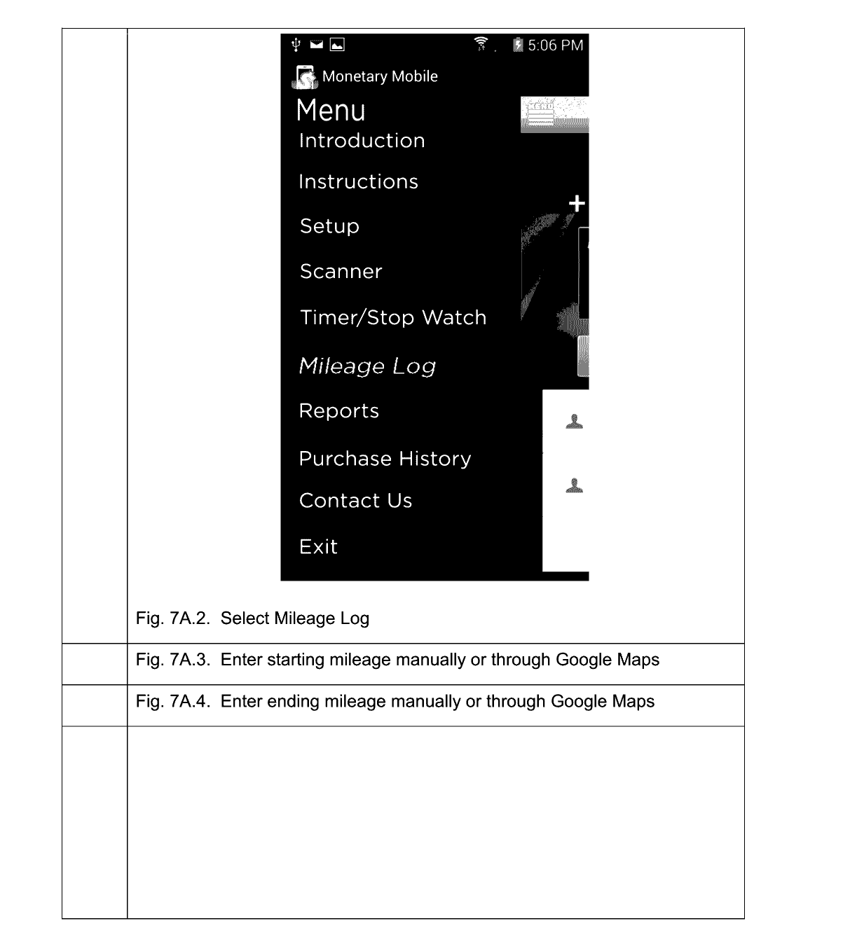

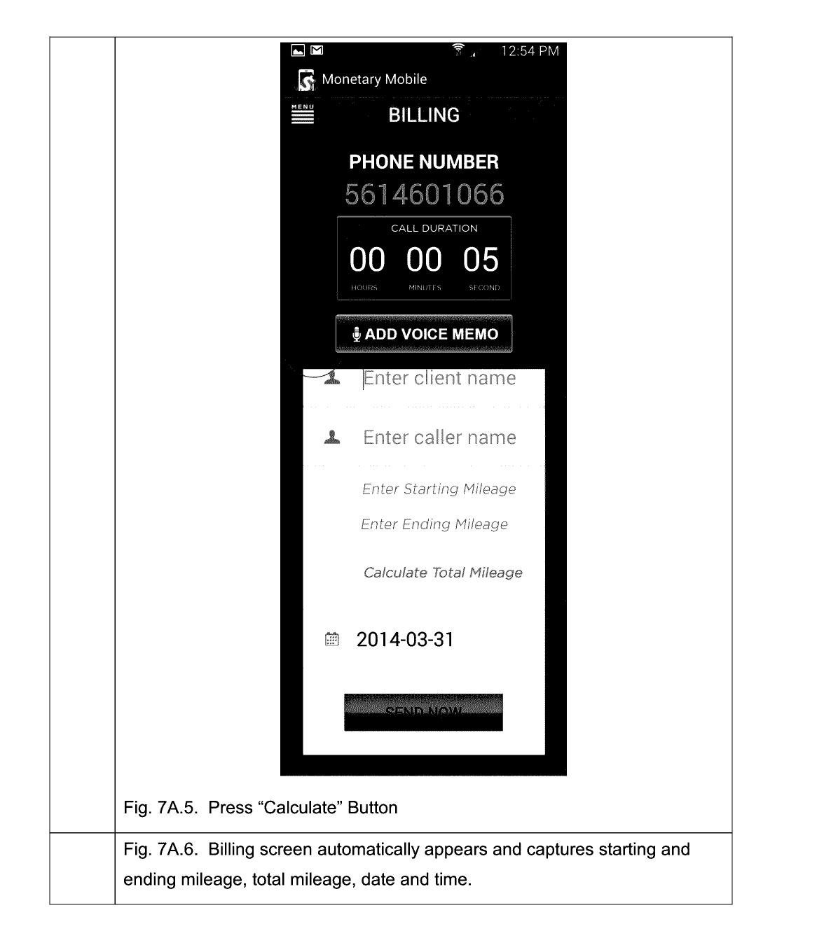

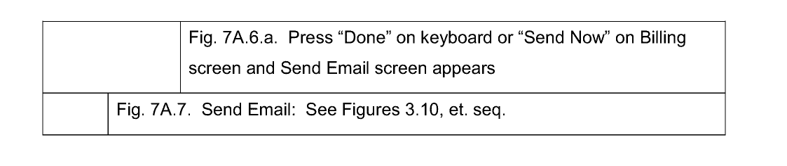

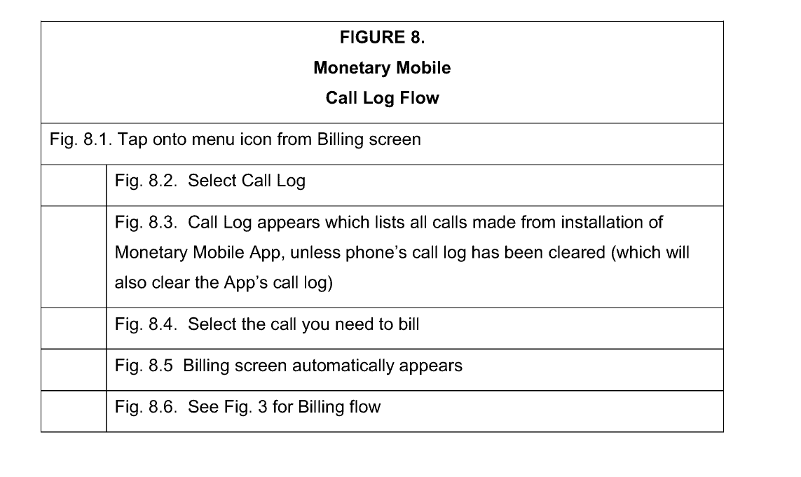

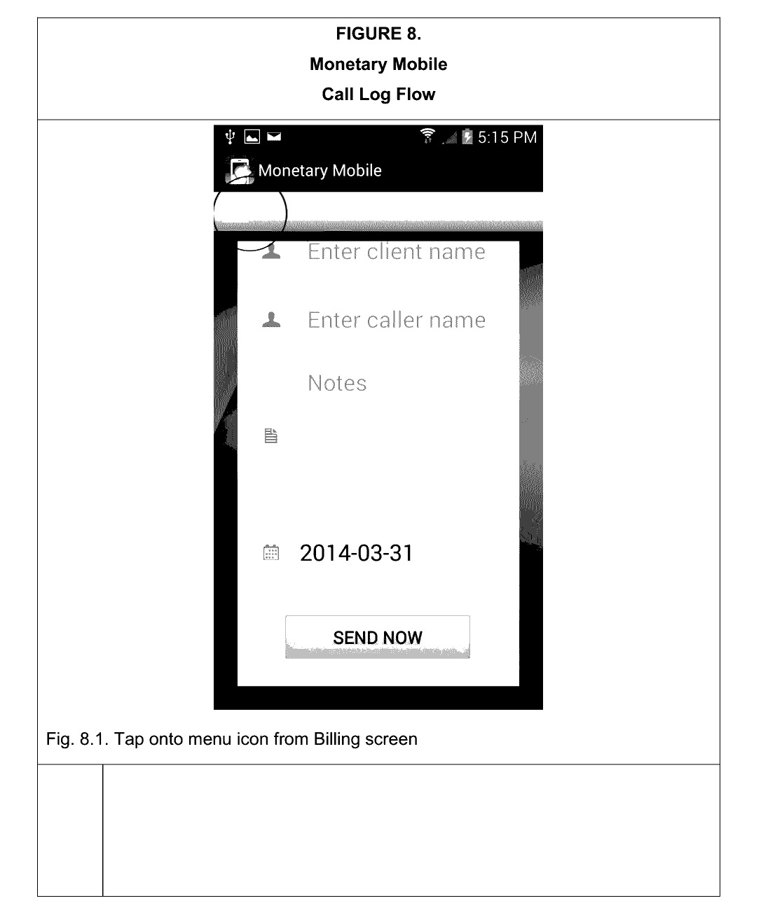

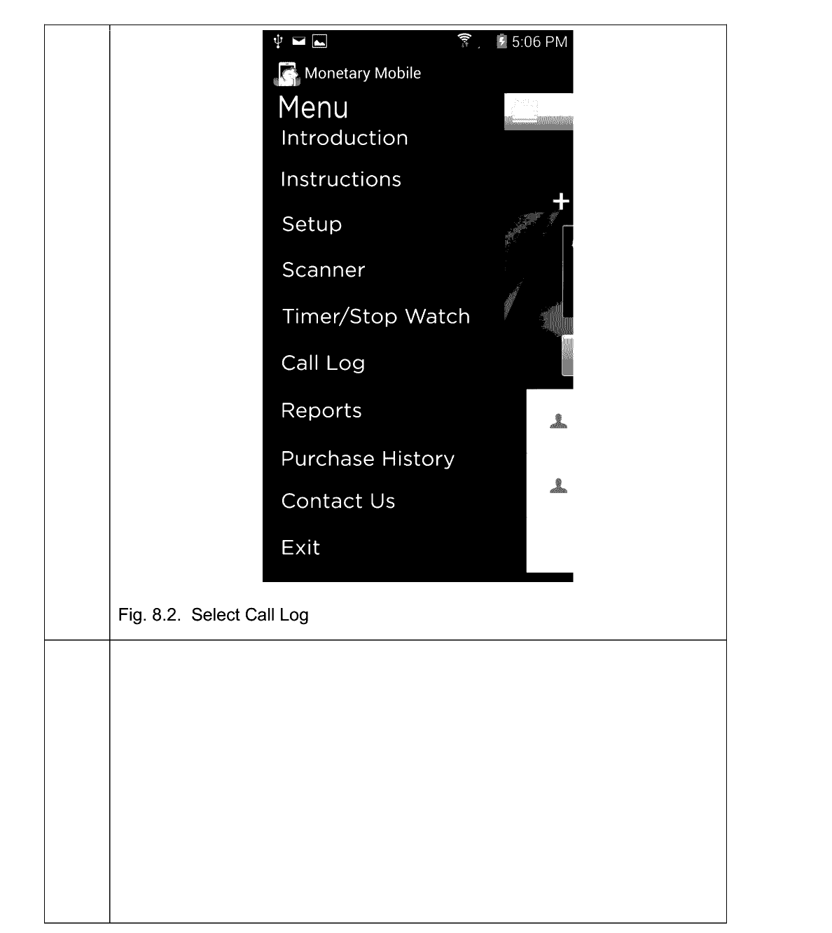

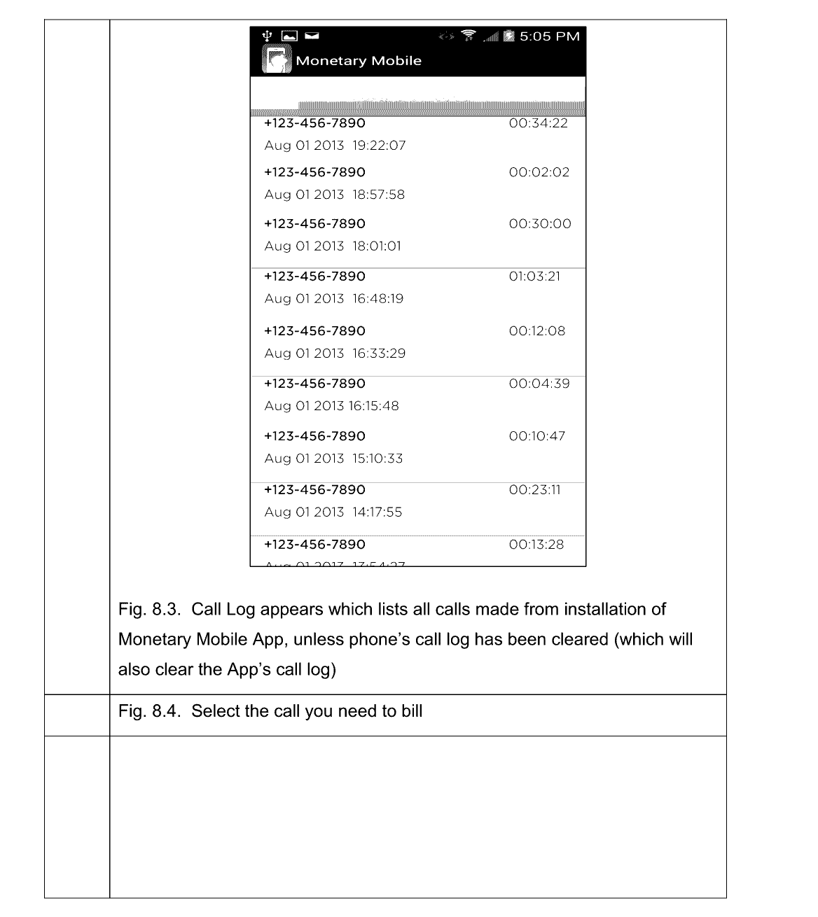

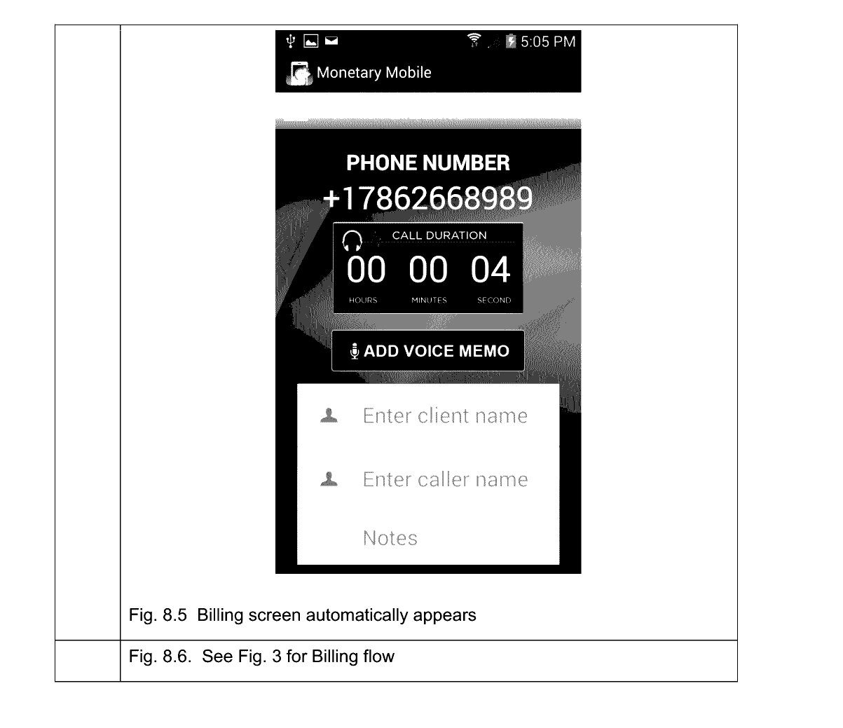

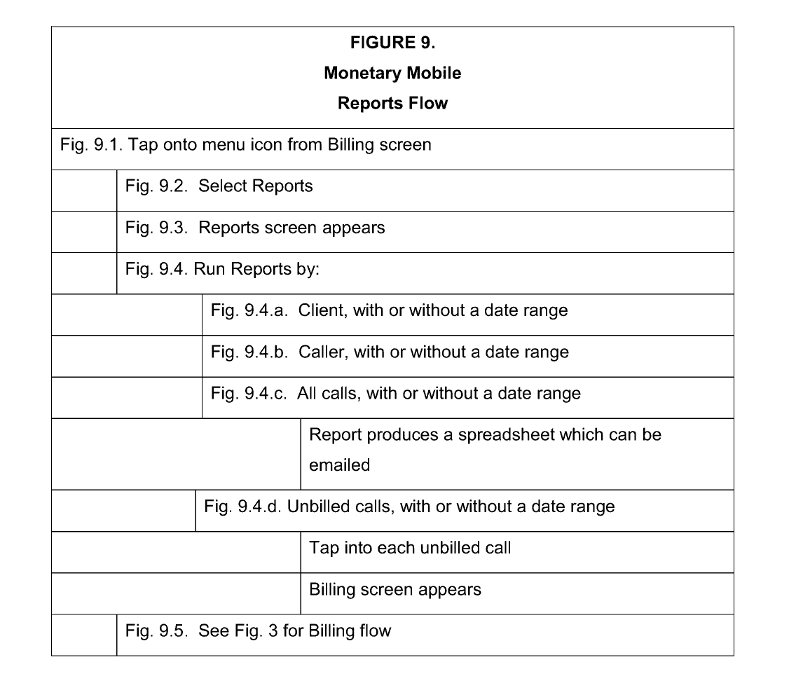

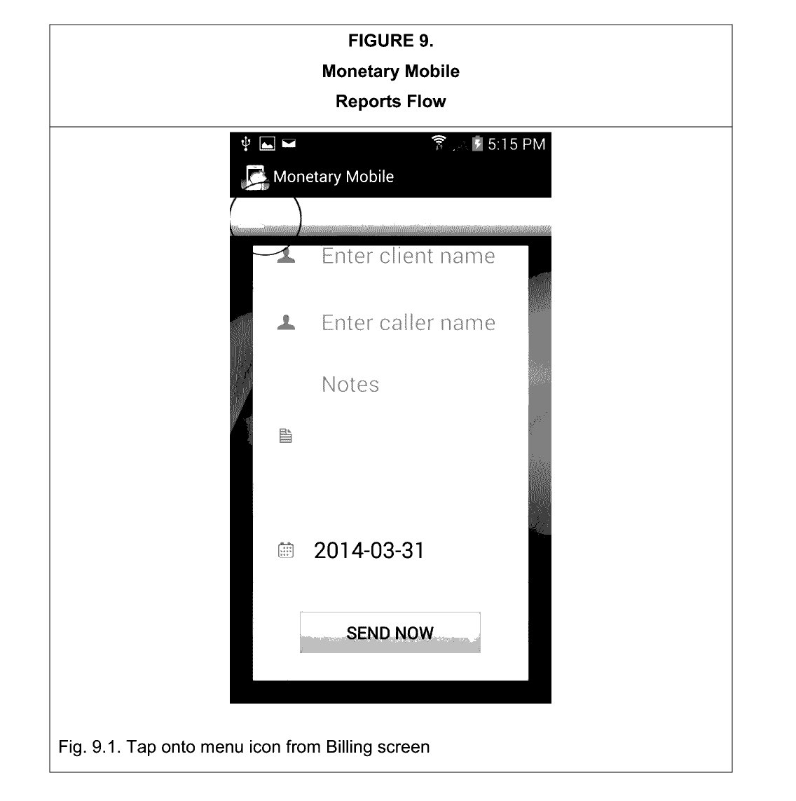

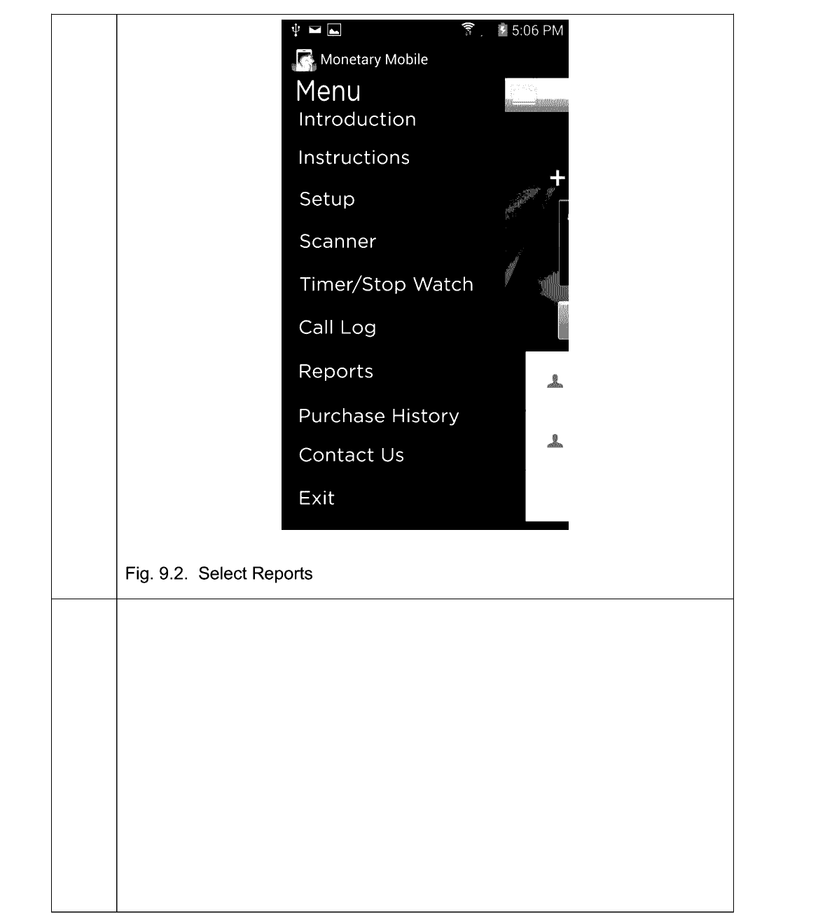

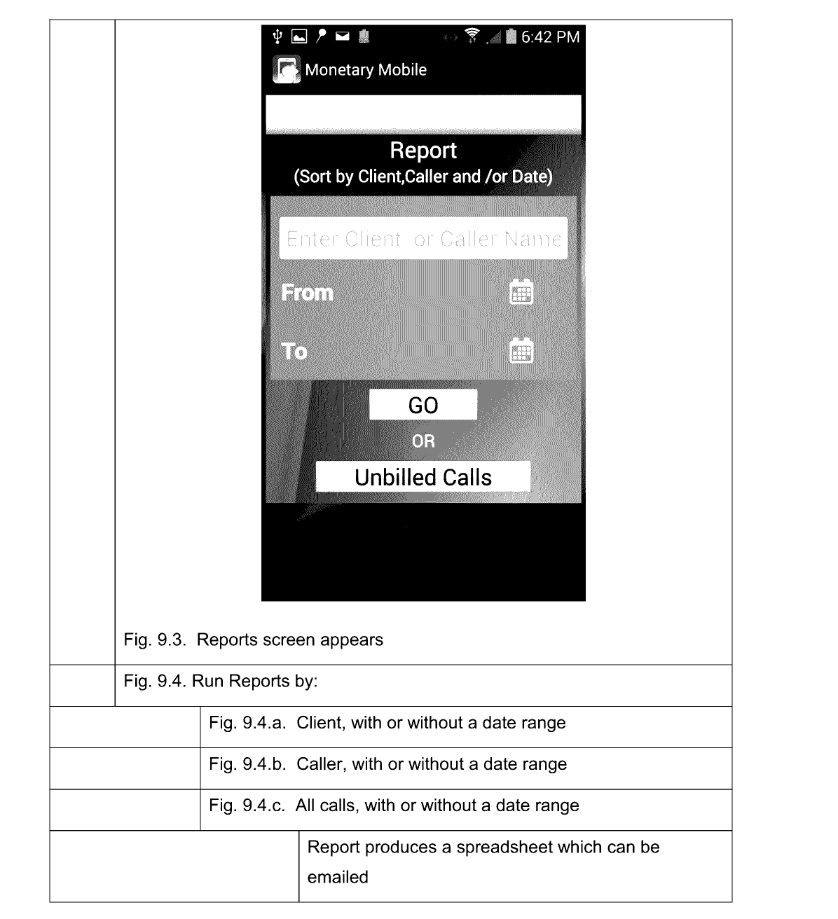

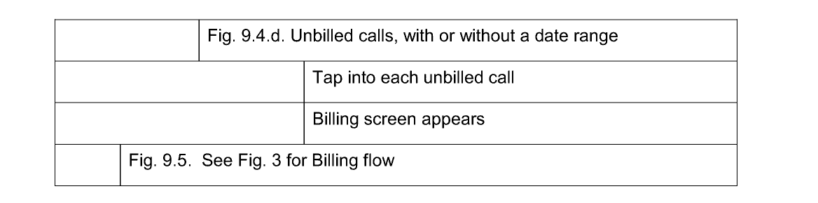

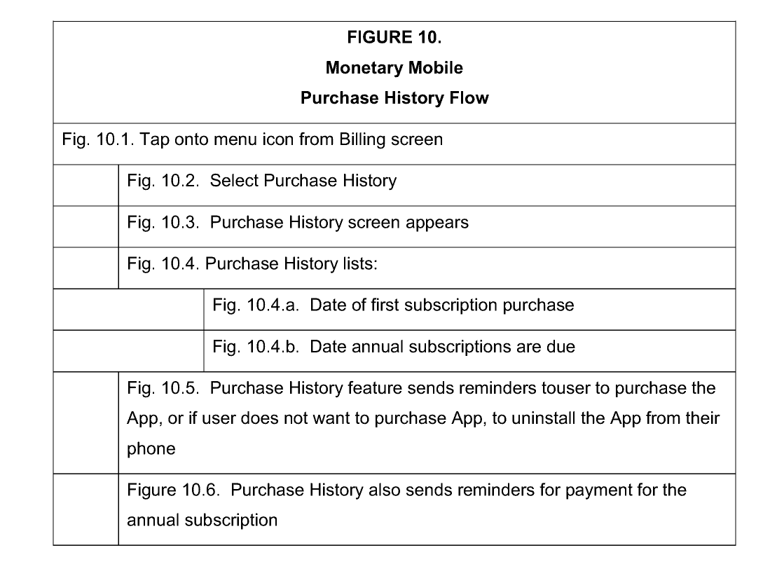

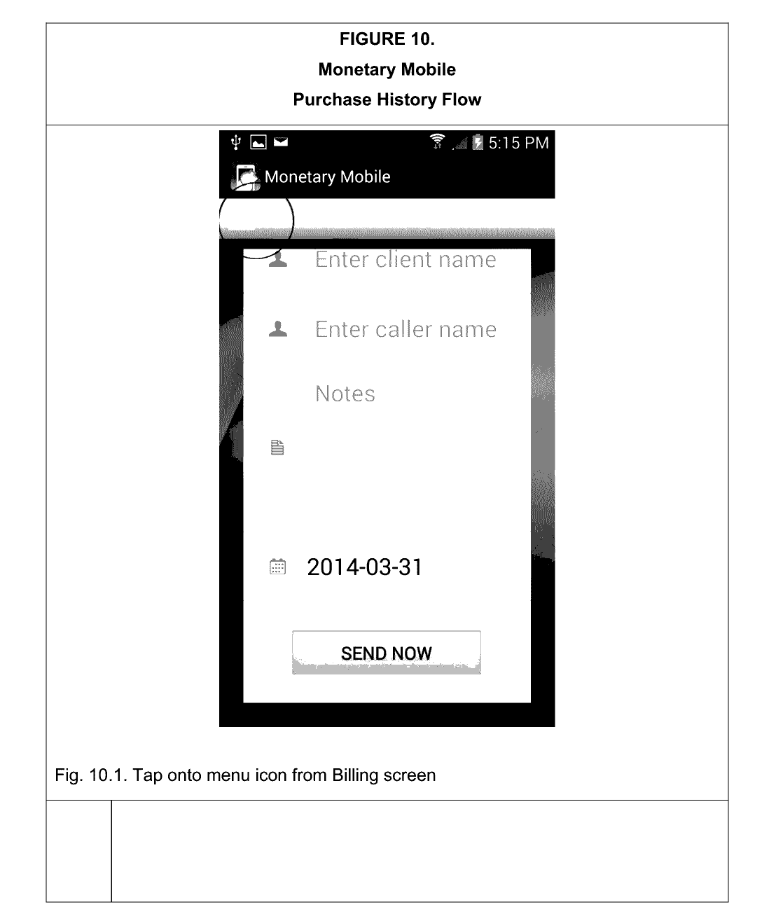

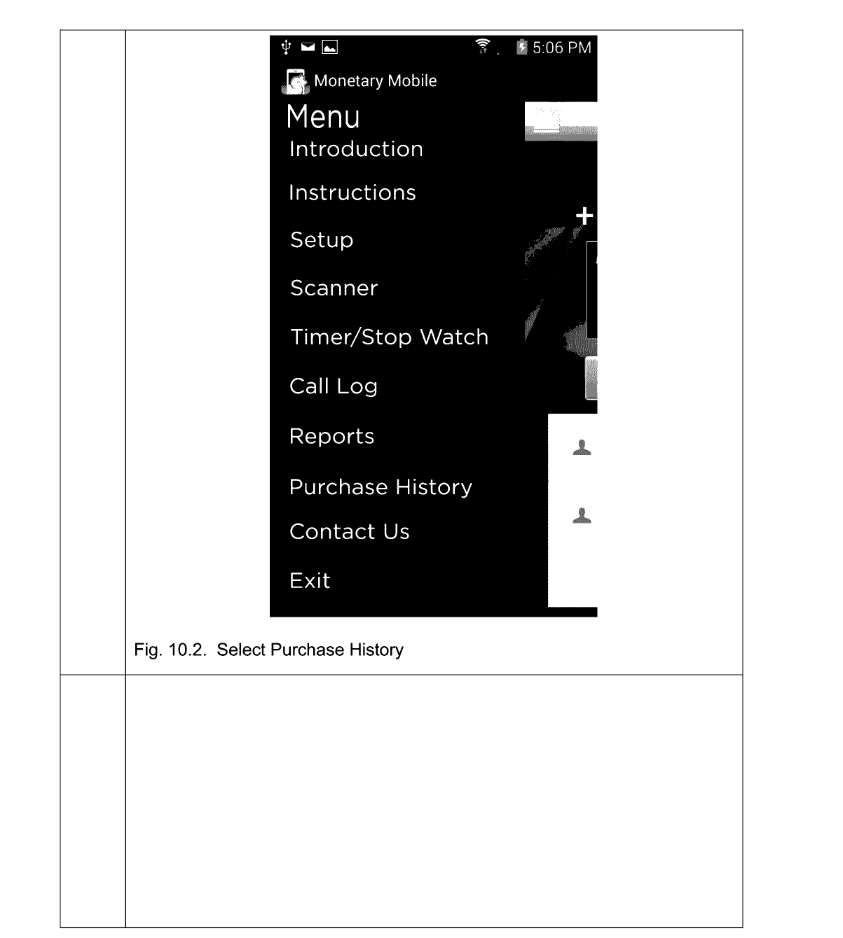

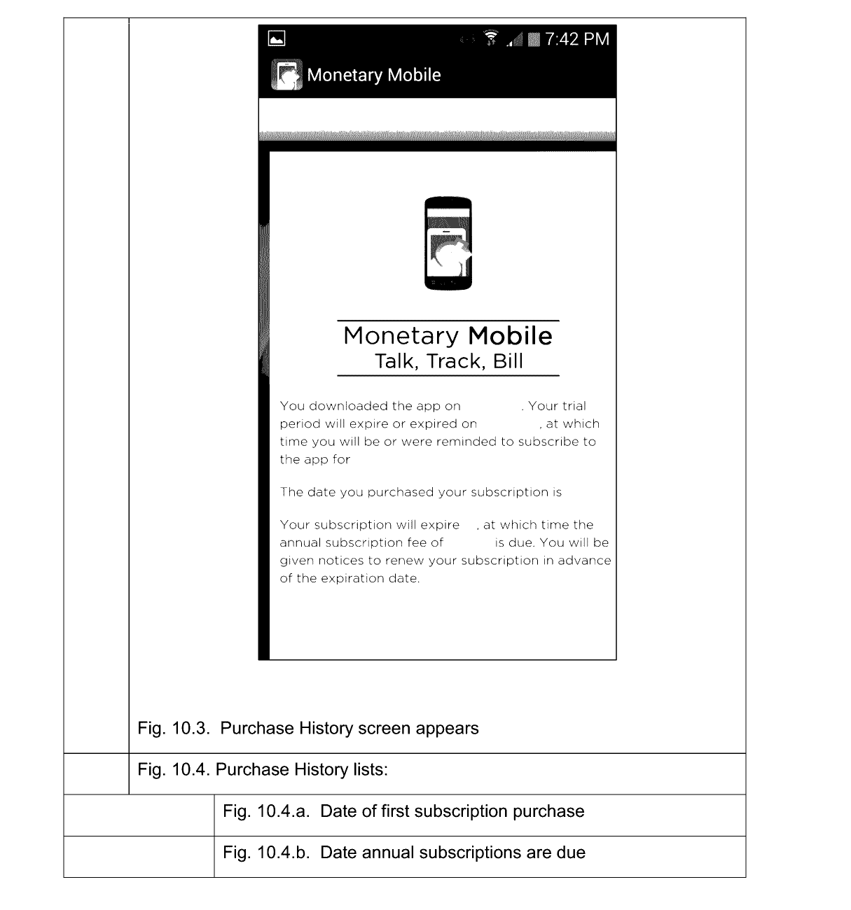

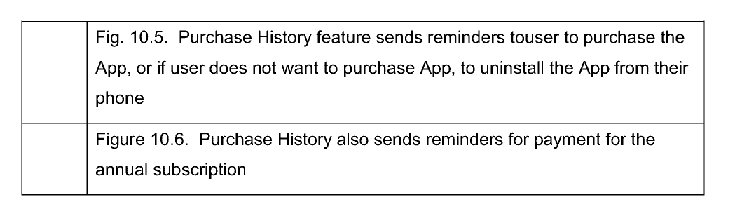

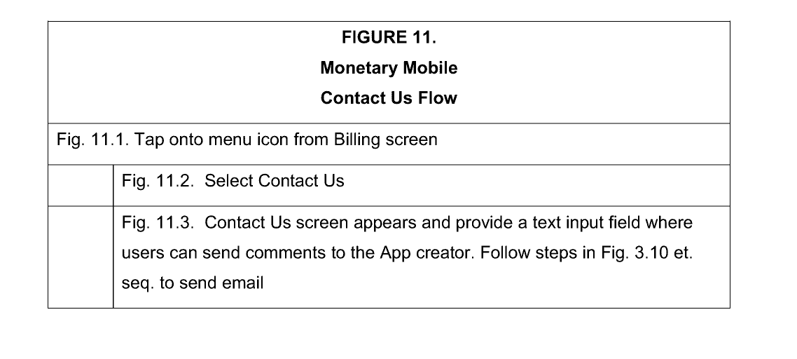

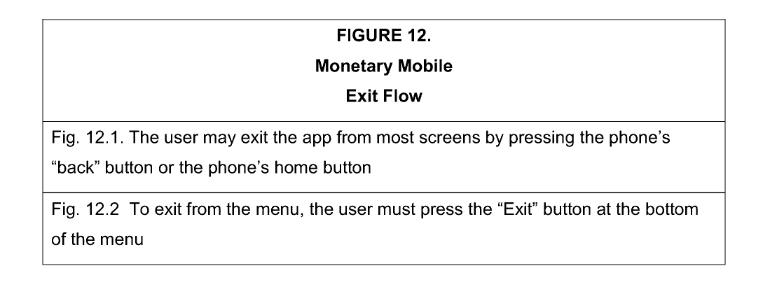

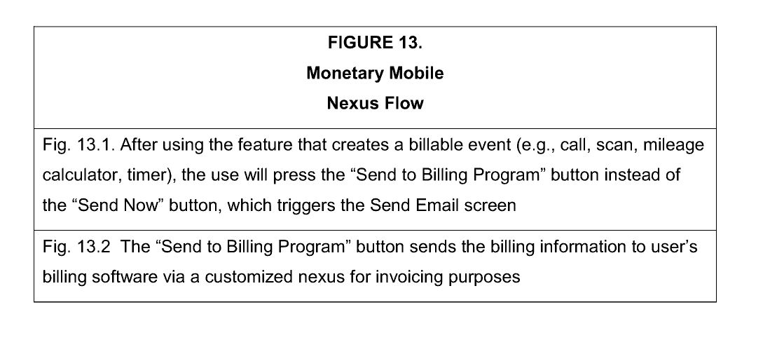

After the app is installed (FIG. 2.1) on the user's phone (either from a PC or Mac or from the platform's app on the user's phone), it requires the user to allow access to certain of the phone's functions so the installation can complete (access is required for the phone, call log, audio, contacts, USB storage, app store billing account, network, accounts on device) (FIG. 2.2). Once the user allows the access to those functions, the installation completes, at which point the user is asked whether s/he wants to open the app (FIG. 2.3). If the user selects no (FIG. 2.3a), the app exits. If the user selects yes (FIG. 2.3b, FIG. 2.4), a flash screen appears (FIG. 2.5) for 1-2 seconds and then the Introduction screen appears (FIG. 2.6). The Introduction is a brief explanation of how the Monetary Mobile app performs and informs the user that there is a 10-day trial period before an annual subscription. When the user finishes reading the Introduction, s/he presses the “Done” button (FIG. 2.6a) to advance to the Instructions screen (FIG. 2.7). When the user finishes reading the instructions, s/he presses the “Done” button (FIG. 2.7a) to advance to the Setup screen (FIG. 2.8). The Setup screen is where the user enters email addresses (FIG. 2.9) where s/he wants descriptions for calls, scans and time to be sent (typically a billing department or assistant). When the user presses “Done,” the app stores the emails and then exits (FIGS. 2.10, 2.10a).

FIG. 2A. “10-Day Trial Period” flow.

After the app is installed (FIG. 2A.1), users have a free 10-day trial period. Before the trial period expires, the app provides notices 3 days, 1 day and 0 days before the expiration of the trial period to either purchase, the app or uninstall to prevent the notices from popping up (FIG. 2A.1.a). The app provides for in-app purchase for the annual subscription (FIG. 2A.2)

FIG. 3. “Disconnect phone call” flow

The core purpose of the app is to help smart phone users, primarily professionals who bill by the hour, capture and describe the time they spend with clients on their phones. FIG. 3 illustrates the app's flow after every call is disconnected.

First, a call is made or received (FIG. 3.1). When the call is disconnected (FIG. 3.2), the app automatically triggers or initiates with a screen to ask whether the user wants to bill the call (FIG. 3.3) and the user selects yes or no. If the user does nothing (FIG. 3.4), the app exits after 30 seconds. If the user selects “No” (FIG. 3.5), the app immediately exits. If the user selects “Yes” (FIG. 3.6), the Billing screen appears (FIG. 3.7).

The app is designed for professionals who bill by the hour, and those professionals usually are required to provide descriptions of the time they bill their clients. The Billing screen captures the phone number of the last call, along with the date, time and length of call (FIG. 3.7). The Billing screen also provides the means for the user to record a description of the call (FIG. 3.8). The “voice memo” button turns green to indicate that it is in recording mode. When the user presses the button again to stop the recording, the button turns red (FIG. 3.8.a). The Billing screen also provides fields for the user to enter descriptions by text (FIG. 3.9), but those fields can be bypassed altogether and the voice memo can be the only description by pressing the “Send Now” button at the bottom of the screen (FIG. 3.8.b).

The Billing screen provides text input fields for additional call description information (FIG. 3.9). FIG. 3.9.a. is the text input field for the “Client Name.” A professional will call or take calls from people other than the actual client, on behalf of that client, so this field is provided for the client's name. FIG. 3.9.b. is the text input field for the “Caller Name.” This will automatically populate if the caller is already in the user's contacts. The app will remember the caller's name the next time that number calls or is called, even if that name is not in the user's contacts.

The Billing screen also provides a field for the user to enter notes (or a description) about the call by text (FIG. 3.9.c). When the user has finished with text input, pressing “Done” on the keyboard or “Send Now” at the bottom of the Billing screen (FIG. 3.9.d) will take the user to the next screen—the Send Email screen (FIG. 3.10). The Send Email screen has tools or apps that will allow the user to send call descriptions to the email addresses set up after the app was downloaded. The Send Email screen (FIG. 3.10) has apps that permit the user to send email through their smart phone, e.g., Evernote app, Gmail, Dropbox, Google Drive, etc. The user simply has to select one of the tools or apps to send the email (FIG. 3.11) Once that tool or app is selected, it will pop up and allow the user to send the email according to that tool or app's instructions (FIG. 3.12). Copies of the email can be saved to the user's email account or cloud storage, depending on which tool was selected. FIG. 3.13 shows the text of the email that is sent to the recipient's email account. After the email is sent, the app exits.

FIG. 4. “Tapping into app” flow

There are many times the user may need to access the app directly from their smart phone, without having to wait to disconnect a call. In order to do that, the user will tap into the app from their smart phone's screen (FIG. 4.1). As soon as the app initiates, the Splash/flash screen appears for one to two seconds (FIG. 4.2). The app then opens to the default screen, the Billing screen (FIG. 4.3). From there, the user may use the Billing screen (FIG. 4.4) or tap the menu icon to access other screens (FIG. 4.5).

Flows for the menu items are described in detail in the following sections.

FIG. 5. “Accessing menu” flow

After the user has accessed the app from their smart phone's screen, the Billing screen appears (See, FIG. 4.3). To access the menu, the user must tap onto the menu icon (FIG. 5.1) in the upper left corner on the Billing screen. The menu (which functions as a table of contents) will then appear (FIG. 5.2) with several selections available. Full descriptions of each menu item will follow this FIG. 5 section.

The first menu item is the Introduction (FIG. 5.3) which gives an overview of the app and its functions. The next item is the Instructions (FIG. 5.4), which describe in minute detail how to use the app. These instructions are a permanent part of the app and can be accessed at any time, which is a very convenient feature for the user.

The Setup screen (FIG. 5.5), which was described in FIG. 2.9, allows the user to enter email addresses where call descriptions are to be emailed. This screen is accessible at any time, in the event the user wants to modify the email recipients (which may typically be a billing department or assistant).

There is also a Scanner function that is accessed from the menu (FIG. 5.6). Once the scanner is open, the user may scan documents, receipts or anything of import that the user needs to save (FIG. 5.6.a). When the scanning operation is finished, the Billing screen appears so the user can describe what the expense was and to whom it should be billed (FIG. 5.6.b).

In order to capture the user's time while in meetings, court hearings, luncheons, etc., the app incorporated a Stop Watch or Timer function (FIG. 5.7). The user will start the timer at the beginning of the event for which the user wants to account (FIG. 5.7.a). When the Timer function is stopped, the Timer Billing screen (FIG. 5.7.b) will automatically initiate for billing purposes.

The menu also provides access to the Call Log screen (FIG. 5.8) so that the user can tap into calls where the billing process may have been interrupted (FIG. 5.8.a).

The app also provides a method to run Reports via the Reports screen (FIG. 5.9). Reports that can be run are by Client, Caller, Date Range, or Unbilled Calls (FIG. 5.9.a).

FIG. 5.10 shows the Purchase History screen that can be accessed from the app's menu. The Purchase History screen shows the date of initial purchase and when the annual subscription for the app is due (FIG. 5.10.a.).

Users will have the opportunity to contact the inventor directly with questions, comments, or suggestions by means of a Contact Us screen (FIG. 5.11), which will send an email through the same services described in FIG. 3.11 for the Send Email screen (FIG. 5.11.a).

Finally, the user may exit from the menu by pressing the Exit tab (FIG. 5.12), which will close the app.

FIG. 6. “Scanner” flow

Professionals/users who travel incur expenses, in their travels and are required to keep track of all receipts (for reimbursement, billing and/or tax purposes). In order to insure that these professionals are able to capture and bill for those expenses, we added a function that will allow users to immediately scan receipts, documents, credit card expenditures, etc. To get to the scanner option, the user will tap into the menu icon from the Billing screen (FIG. 6.1). From there the user will select the scanner option (FIG. 6.2). The scanner activates via the phone's camera (FIG. 6.3). The user will then scan the expense item, receipt, credit card transaction or document (FIG. 6.4) and those scanned items will attach to the user's email as PDF files. After scanning, the user presses the “Done” button (FIG. 6.5) and the Billing screen appears (FIG. 6.6).

The Billing screen automatically captures the date and time and provides text input fields for client name and notes, as well as the ability to add a voice memo. (FIG. 6.7). When the user has finished with text input, pressing “Done” on the keyboard or “Send Now” at the bottom of the Billing screen (FIG. 6.7.a) will take the user to the next screen—the Send Email screen (FIG. 6.8). See FIG. 3.10 et seq. for email flow.

The scanner function has the option to scan a single page or multiple pages and email the scanned documents as PDF files as described above.

FIG. 7. “Stop watch/timer” flow

Professionals/users who travel need to keep track of the number of hours they spend in court hearings, meetings, traveling, conferences with clients, etc., and they are required to keep detailed records of that time. In order to insure that these professionals are able to capture and bill for that time, we added a timer or stop watch function that will allow users to keep accurate time they spend with clients or in outside appointments.

To get to the timer option, the user will tap into the menu icon from the Billing screen (FIG. 7.1). From there the user will select the timer option (FIG. 7.2). The timer activates via the phone's clock (FIG. 7.3). When the user finishes the meeting or billable event, the user simply taps onto the timer again to stop it. (FIG. 7.4) and the Billing screen appears (FIG. 7.5). The Billing screen automatically captures the date, start time, finish time and the total amount of time. It provides text input fields for client name and notes, as well as the ability to add a voice memo. (FIG. 7.6). When the user has finished with text input, pressing “Done” on the keyboard or “Send Now” at the bottom of the Billing screen (FIG. 7.6.a) will take the user to the next screen—the Send Email screen (FIG. 7.7). See FIG. 3.10 et seq. for email flow.

FIG. 7A. “Mileage log” flow

Professionals/users who travel need to keep track of their mileage for billing, logging, or tax purposes. In order to insure that these professionals are able to capture and bill for their mileage, we added a manual mileage tracking feature that will allow users to keep track of all business trips for reimbursement or billing, or trips that can be deducted for income tax purposes.

To get to the Mileage Log option, the user will tap into the menu icon from the Billing screen (FIG. 7A.1). From there the user will select the Mileage Log option (FIG. 7A.2). The user will manually enter the starting mileage (for the beginning of the trip) FIG. 7A.3). At the end of the trip, the user enters the ending mileage (FIG. 7A.4). The app automatically calculates the mileage when user presses the “Calculate” button (FIG. 7A.5). The Billing screen appears (FIG. 7A.6). and automatically captures the date, time, starting mileage, ending mileage and the total mileage. It provides text input fields for client name and notes, as well as the ability to add a voice memo. (FIG. 7A.7). When the user has finished with text input, pressing “Done” on the keyboard or “Send Now” at the bottom of the Billing screen (FIG. 7.6.a) will take the user to the next screen—the Send Email screen (FIG. 7A.7). See FIG. 3.10 et seq. for email flow.

FIG. 8. “Call log” flow

Occasionally users get interrupted (either from another phone call coming in, too many apps running in the background, etc.) when they are entering information about a call on the Billing screen and the description of the call does not get emailed. When that happens, the user can go to the app's Call Log screen to select the call and complete the call description as set forth in FIG. 3.7, et seq.

To get to the Call Log screen the user will tap into the menu icon from the Billing screen (FIG. 8.1). From there the user will select the Call Log option (FIG. 8.2), and the Call Log screen appears which lists all calls made from the date of installation of the app (FIG. 8.3). The user can scroll through the calls to select the one s/he wants to bill (FIG. 8.4); after the call is selected, the Billing screen automatically appears (FIG. 8.5) and the user can add the billing information as described in FIG. 3. “Billing” flow (FIG. 8.6).

FIG. 9. “Reports” flow

The app allows users to run various reports via the Reports screen (FIG. 9). To get to the Reports screen, the user will tap into the menu icon from the Billing screen (FIG. 9.1). From there the user will select the Reports option (FIG. 9.2). The Reports screen appears (FIG. 9.3) and provides fields for running reports (FIG. 9.4). The user can run reports by Client, with or without a date range (FIG. 9.4.a); Caller, with or without a date range (FIG. 9.4.b); all calls, with or without a date range (FIG. 9.4.c); or Unbilled calls, with or without a date range (9.4.d). The reports for Client, Caller or All Calls are summarized in spreadsheets and can be emailed to the recipients that were entered on the Setup screen (FIG. 2.9) and emailed as shown in FIG. 3.10, et seq.

FIG. 10. “Purchase history” flow

So the user can check when his annual subscription is due, the app provides a Purchase History screen.

To get to the Purchase History screen, the user will tap into the menu icon from the Billing screen (FIG. 10.1). From there the user will select the Purchase History option (FIG. 10.2). The Purchase History screen appears (FIG. 10.3) and lists (FIG. 10.4) the date of the first subscription purchase (FIG. 10.4a) and the date the next annual subscription is due (FIG. 10.4.b). The Purchase History screen notifies users to purchase the app before the trial period is up or to uninstall the app to de-activate the notifications (FIG. 10.5). The Purchase History screen also notifies the user when the annual subscription is due (FIG. 10.6).

FIG. 11. “Contact us” flow

If the user wants to contact the app developer for any reason, the app provides a Contact Us screen for the user's convenience.

To get to the Contact Us screen, the user will tap into the menu icon from the Billing screen (FIG. 11.1). From there the user will select the Contact Us option (FIG. 11.2). The Contact Us screen appears (FIG. 11.3) and provides a field for the user to send a message. Follow the steps shown in FIG. 3.10 et seq. to send email.

FIG. 12. “Exit” flow

The user may exit the app from most screens by completing the tasks required on the screen, by pressing the phone's “back” button, or by pressing the phone's “home” button (FIG. 12.1). To exit from the Menu, the user should select the Exit option (FIG. 12.2), and the app will close.

FIG. 13. Nexus flow

Monetary Mobile is strictly an application for capturing calls, time, expenses and mileage for professionals on the go; the app forwards descriptions to predesignated recipients by email (FIG. 13.1). The time and expenses, must be billed to the client via the professional's billing software, not through the app.

To make Monetary Mobile even more useful, we custom designed a nexus between the application and the most popular billing programs for the legal profession, so that descriptions can go directly into the billing software for invoicing to clients. After the user completes the Billing screen (FIG. 13.2) and the billing screens have been completed, the billing information is converted to match the user's billing software for invoicing purposes.

1: The most unique feature of this invention (“app”) is that it triggers immediately when a call disconnects to remind the user to bill for the call. If the user wants to bill for the call, s/he presses the “Yes” button to engage the billing screen, from which the user will enter client and caller information and a description of the purpose of the call, either by voice memo or text input. When finished the user is prompted to email the call description to his/her billing department, assistant, or him/herself. To the best of the knowledge of the inventor, after diligent search and inquiry, no other mobile application has this same feature. With this feature, a professional/user cannot forget to bill for a conversation with or on behalf of a client.

2: The app provides a scanning function primarily for the ability to scan receipts or expense items and email those via a similar billing screen to his/her billing department, assistant, or him/herself. Documents for pre-trial discovery or due diligence purposes can also be scanned and assigned to a client via the billing screen. The scanned documents, receipts or expense items are saved in PDF format attached to the email. To the best of the knowledge of the inventor, after diligent search and inquiry, no other mobile application has this same feature. With this feature, a professional/user will have a permanent copy of the item and can assign expenses or documents directly to a client, or preserve records for tax purposes or reimbursement purposes.

3: The app provides a stop watch function so that if the user (who typically bills by the hour) is working on a particular matter, s/he can keep accurate track of the time. The user activates the stop watch by pressing the “Start” button. As soon as the user is finished, s/he presses the “Done” button, which prompts the billing screen to appear so that the time is immediately captured as described above, and then emailed to the user's billing department, assistant or him/herself. To the best of the knowledge of the inventor, after diligent search and inquiry, no other mobile application has this same feature. With this feature, a professional/user will have a permanent record of the time spent in meetings, court, networking, etc., and can bill the exact amount of time to a client, or use the tool as a time management tool.

4: The app provides a mileage calculator so the user can have an exact and permanent record of trips taken on behalf of client, so the client can be billed for that mileage. Also, this feature creates a permanent and accurate record for reimbursement or tax records purposes. To the best of the knowledge of the inventor, after diligent search and inquiry, no other mobile application has this same feature. With this feature, a professional/user will have a permanent record, along with detailed description of the details of the trip which can be billed directly to a client or used for tax purposes or reimbursement purposes

5: An extended version of the app links directly with the user's billing programs so that the information collected by the app and provided by the user will integrate directly into the billing program. To the best of the knowledge of the inventor, after diligent search and inquiry, no other mobile application has the same features as this invention, especially the one in which the app triggers instantly after a call is disconnected. This feature provides an immediate reminder to bill specifically for phone calls on behalf of clients, as well as the other features which provide a very simple way to capture time and expenses and immediately and easily capture billing information which can then be sent directly to the user's billing program instead of being emailed as described herein.

6: The Call Log retains all calls; tapping into any call in the call log will trigger the billing screen so the user can bill (or log) for any unbilled (or unlogged) call when s/he was not able to bill for the call immediately upon disconnect. To the best of the knowledge of the inventor, after diligent search and inquiry, no other mobile application has this same feature. As stated in claim 1 above, the app provide a simple method of capturing and describing calls that can be billed or logged. Even if the user cannot immediately bill or log a call when it is disconnected, the user can go into the app's call log, select a call that still needs to be billed and initiate the billing screen with a simple tap. This is a unique feature as well.

7: The Reports function allows the user to run reports by client, caller, or all calls with or without a date range. The foregoing reports can be emailed to the user's billing department, assistant or him/herself and are attached as spreadsheets. Further the Reports function allows for a report to be run for all unbilled calls. This will produce a call log when the user can access, call by call, to trigger the billing screen. To the best of the knowledge of the inventor, after diligent search and inquiry, no other mobile application has this same feature. The ability to run reports and have them emailed is a unique feature of this invention. The Reports feature provides several options that are absent in other mobile applications that may have any type of report function. The ability to email those reports is a unique feature of this invention.

8: The Purchase History function shows the user the date the app was purchased and date the next annual subscription is due. Also through this feature, the app sends the user several notices before the trial period expires, before the first annual subscription payment is due.

9: The Contact Us screen allows the user to contact the inventor directly with comments, questions, suggestions, etc. While this feature is not necessarily unique to this app, it is convenient especially when combined with the other unique features the invention provides.

10: The app provides a screen with an Introduction and a screen with Use Instructions, both of which are easily accessed at any time through the app's menu. This may not be unique either, but it does provide a convenient way for the user to quickly get instructions (in particular) for using all features of the app.

11: The Setup Function allows the user to enter email addresses where call descriptions are to be sent for billing or logging purposes. This triggers immediately after installation of the app onto the user's mobile phone and is a menu item so changes can be easily made. To the best of the knowledge of the inventor, after diligent search and inquiry, no other mobile application has this same feature. This feature is unique with the setup feature because of what the user is setting the app up to do: send information or descriptions about calls, time, expenses, documents, and reports directly to the user's office (billing department, assistant, him or herself, etc.). Typically, this information is used by the app developer as a means to direct communications to the user potentially for marketing purposes. This invention only saves the emails to the user's phone, not to an external database. The inventor or assignee has no access to this private information.
